(19) United States
(12) Patent Application Publication
(10) Pub. No.: US 2012/0290323 A1
(43) Pub. Date: Nov. 15, 2012

(54) INTERACTIVE VISUALIZATION FOR HEALTHCARE

(76) Inventors: Wael K. Barsoum, Bay Village, OH (US); Michael W. Kattan, Cleveland, OH (US); William H. Morris, Shaker Heights, OH (US); Douglas R. Johnston, Shaker Heights, OH (US)

(21) Appl. No.: 13/469,281

(22) Filed: May 11, 2012

Related U.S. Application Data
(60) Provisional application No. 61/484,902, filed on May 11, 2011.

(51) Int. Cl. G06Q 50/24

(52) U.S. Cl. 705/3

(57) ABSTRACT

This disclosure relates to a visualization tool that can be implemented to facilitate medical decision making by providing an interactive graphical map of relevant health data. The interactive map can include graphical elements representing health data that can be obtained from an EHR and associations between such data that are represented by graphical connections. The graphical elements and associations can be modified to reflect medical decision making.

### CROSS-REFERENCE TO RELATED APPLICATION

This application claims the benefit of U.S. Provisional Patent Application No. 61/484,902, filed May 11, 2011, and entitled DIAGNOSTIC MAPPING, the entire contents of which is incorporated herein by reference.

### TECHNICAL FIELD

This disclosure relates to health care and more particularly to an interactive visualization of healthcare information.

### BACKGROUND

Electronic medical records (EMRs) are used in the healthcare industry to facilitate storage, retrieval and modification of management of health care information records. The change from paper records to EMR based systems is being accelerated at least in part in the U.S. due to the American Recovery and Reinvestment Act of 2009. The EMR is used to document aspects of patient care and billing for healthcare services, typically resulting in voluminous data is stored and accessed for patients. The user interfaces for EMR systems tend to be quite rigid. For example, the user interfaces are often modeled similar to the paper charts that they were intended to replace. Additionally, use of such EMR systems can be oftentimes frustrating to healthcare providers due to the voluminous amounts of data stored in an EMR database.

### SUMMARY

This disclosure relates to health care and more particularly to an interactive visualization of healthcare information.

As one example, a system for visualizing health information can include a repository interface to access health data objects for a given patient from an electronic health record (EHR) repository. Association data can be stored in memory separate from the EHR repository, the association data representing a link between selected health data objects for the given patient. A visualization engine can dynamically generate an interactive graphical map representing selected health data objects as graphical elements and representing links between the selected health data objects as graphical connections between related graphical elements based on the association data.

As another example, a non transitory computer readable medium can store instructions for performing a method. The method can include accessing health data objects for a given patient from an electronic health record (EHR) system. The method can also include storing association data to represent a link between health data objects for the given patient, the association data being stored separately from the EHR system. The method can also include dynamically generating an interactive graphical map representing selected health data objects as graphical elements and representing links between the selected health data objects as graphical connections between related graphical elements based on the association data.

### BRIEF DESCRIPTION OF THE DRAWINGS

FIG. 1 depicts an example block diagram of a system for implementing diagnostic mapping.

FIG. 2 depicts an example of a diagnosis engine.

FIGS. 3, 4 and 5 depict an example of a graphical user interface that can be utilized for diagnostic mapping according to an embodiment.

FIGS. 6, 7, 8 and 9 depict an example of a graphical user interface that can be utilized for performing diagnostic mapping according to another embodiment.

FIGS. 10, 11, 12, 13 and 14 depict examples of a graphical user interface in the context of some diagnoses and supporting evidence that can be implemented according to an embodiment.

FIG. 15 depicts an example of a launch graphical user interface screen that can be implemented as an entry point into the diagnostic mapping system.

FIG. 16 depicts an example embodiment of an administration graphical user interface screen that can be implemented as part of the diagnostic mapping system.

FIG. 17 depicts an example embodiment of an administration graphical user interface showing activation of a patient list feature.

FIG. 18 depicts an example of a graphical user interface showing a transition of care user interface screen for a given patient.

FIG. 19 depicts an example embodiment of a graphical user interface demonstrating a patient status user interface screen.

FIG. 20 depicts an example of a computer architecture in which the diagnostic mapping system can be implemented according to an embodiment.

FIG. 21 is a flow diagram depicting an example of a method for providing interactive visualization of healthcare information.

### DETAILED DESCRIPTION

This disclosure relates to health care and more particularly to an interactive visualization of healthcare information.

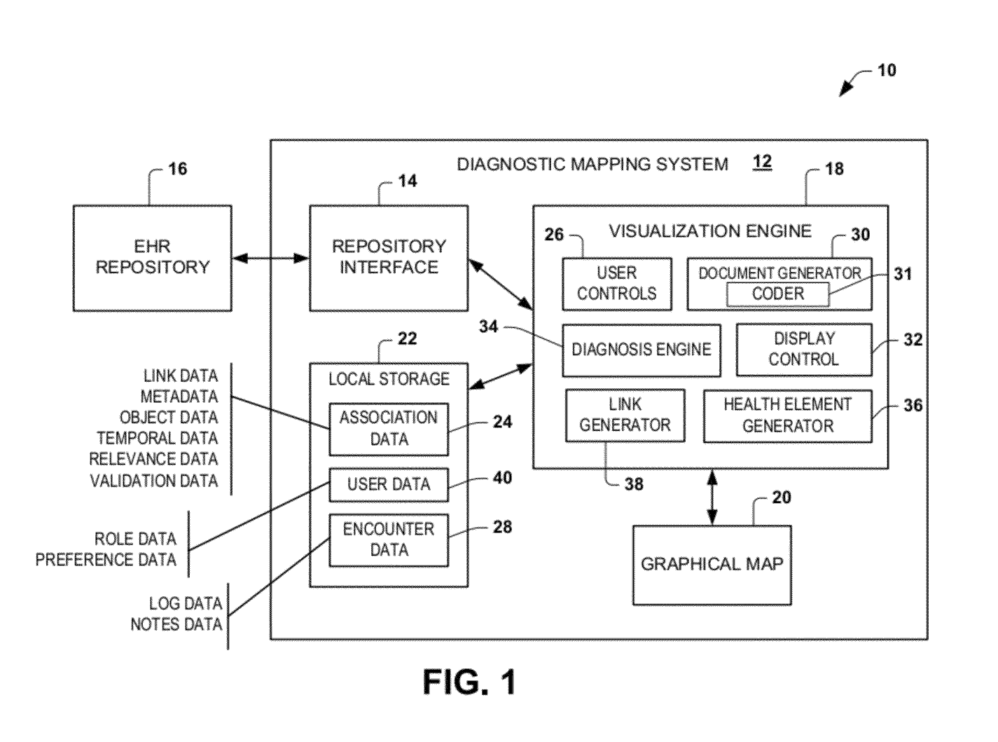

FIG. 1 depicts an example of a visualization system 10 that can be implemented according to an embodiment. The system 10 includes a diagnostic mapping system 12 that is programmed to visualize healthcare information. The mapping system 12 can be implemented to include data and computer readable instructions, which when executed by a processor, perform a method as disclosed herein. The healthcare information can include diagnostic-related information for one or more individuals (human or otherwise), administration information for a facility, practice or institution as well as any other information that can be useful in providing care or managing the provision of care.

The diagnostic mapping system 12 includes a repository interface 14 that is programmed to access health care data objects for any number of one or more patients from an electronic health record (EHR) repository 16. For example, the repository interface 14 can be programmed to pull (e.g., retrieve) data from the EHR repository 16 in response to instructions from a visualization engine 18. Additionally, the repository interface 14 can include methods and functions programmed to push data to the EHR repository 16 also in response to instructions from the visualization engine 18.

The diagnostic mapping system 12 can be implemented in a variety of healthcare environments including hospitals, private practices, networks of hospitals or the like. Accordingly, the number of patients and the amount of data stored in the EHR repository 16 can vary depending upon the implementation of the system 10. It is to be understood and appreciated that in a given network or enterprise the EHR repository 16 can correspond to one or more different types of EHR systems that may be implemented in different locations or for different portions of the given network or enterprise. Accordingly, the interface 14 can be extensible and appropriately programmed to selectively push and pull data for each such EHR system that may be utilized.

The visualization engine 18 is programmed to generate an interactive graphical map representing selected health data objects from the EHR repository 16 as graphical elements. Additionally, the visualization engine 18 can represent associations between corresponding health data objects as corresponding graphical connections in the graphical map. The associations between the health data objects are stored as part of local storage 22, which can be stored in a data structure or database that is separate from the EHR repository 16. For example, the local storage 22 can include association data 24 that is stored in memory separate from the EHR repository 16. The association data can be generated in response to a user input and/or based on information stored in the EHR repository. The association data 24 can thus include link data that represents the links between underlying health data objects (from the EHR repository 16) for each given patient.

The association data 24 can also include relevance data. The relevance data can be a quantitative value that corresponds to a relevance between two or more health data objects for each link. The relevance data can define confidence value that the health data objects being linked are related. The value can be stored as an integer or floating point value that maps graphically to a distance parameter between the associated pair of graphical elements, for example. As other supporting evidence is collected and analyzed, the relevance data can for each of the graphical elements can be dynamically updated accordingly. The distance parameter can be adjusted according to the display resolution capabilities of the output device where the map is being displayed. The distance parameter can correspond to an on-screen distance between graphical elements and/or affect other display parameters (e.g., brightness, thickness, color, size and the like) that can graphically demonstrate a confidence of the causal relationship between elements. While the examples shown herein are demonstrated as two-dimensional, it is appreciated that the concepts are equally applicable to three-dimensional interactive graphical maps and four-dimensional maps (e.g., the fourth dimension being time). For instance, the graphical elements and links can be arranged hierarchically in three-dimensions according to their relative importance in driving a diagnosis for the given patient.

The relevance value can be computed and assigned automatically. Alternatively, the relevance data can be specified in response to a user input (e.g., a provider may set the relevance by adjusting a distance between graphical objects including overriding a computed value) based on professional judgment. The visualization engine 18 can generate the graphical map 20, based on the relevance data, such as to graphically differentiate a relevance (e.g., importance) of selected health data objects and the links between each pair of associated data objects. The relevance data can be programmed in response to a user input (e.g., specifying the relevance explicitly and/or graphically), based on data stored in the EHR repository 16 or can be determined from other sources.

The visualization engine 18 can graphically represent the relevance of such objects and corresponding links in a variety of different ways. For example, the visualization engine 18 can define the graphical connections between the graphical health data elements based on association data 24, such as by varying the type or form of graphical connection between the graphically health objects. As an example, the visualization engine 18 can generate the graphical connection with a relative graphically-represented parameter, which is stored as part of the association data. Relative in this context refers to how a given graphical connection is visualized in a graphical display when compared to how one or more other graphical connections in the same graphical display are concurrently visualized. For example, the relative graphically-represented parameter can include a relative length parameter, a relative thickness parameter, or a combination of different relative parameters that can graphically represent the determined relevance defined by the relevance data. As a further example, for a given diagnosis, graphical objects, corresponding to different contributing factors to the diagnosis, can also be graphically displayed with different relative parameters, such as relative sizes and/or and distances apart from the diagnosis object, depending on each factor's contribution to the diagnosis.

Additionally, the visualization engine 18 can represent the graphical elements in the graphical map 20 based on object data and metadata that is stored in memory as part of the association data 24 in the memory storage 22. Graphical elements in the map 20 can include iconic-type or other predefined graphical representations for different types of patient health data objects. For example, health data objects such as diagnoses and supported evidence such as lab data, orders, radiology information, and risk factors can be represented graphically as different icons that include graphical and/or textual information. For example, the object data can be stored as part of the local storage 22 for each of the health data objects, which are retrieved from the EHR repository or created within the diagnostic mapping system 12.

Metadata (e.g., data that describes the data objects and data associations) can also be stored as part of the association data 24. Such metadata can thus be utilized to provide additional information about a given element or graphical connection (e.g., corresponding to a link between data objects). For instance, corresponding metadata can be employed to present information in a textual and/or graphical manner in response to hovering a pointing element over or otherwise selecting a given graphical element or connection. The additional information presented based on the metadata associated with such selected element can be graphically presented in a superimposed relationship or adjacent to the selected element, such as a pop-up window or other form of representation.

The visualization engine 18 also includes user controls 26 to provide for user interaction with graphical elements and links that are presented as part of the graphical map 20. The user controls 26 allow an authorized user to create new health data objects, such as corresponding to a diagnosis or problem (e.g., from a problem list stored in the EHR repository 16, or supporting evidence, as well as links between such evidence and the diagnosis. The user controls 26 can be programmed to modify the interactive graphical map 20 in response to user inputs such as can be made via a pointing element that is controlled by a user input device (e.g., a mouse, touch-screen, or other human machine interface). Thus, the user controls 26 are programmed to provide for user interaction and manipulation of the interactive graphical map 20 and its various components that are presented as part of the graphical map.

As disclosed herein, each of the graphical elements and graphical connections between corresponding elements correspond to health data objects and associations (e.g., relationships or links) between such objects. Thus, as a user manipulates the graphical objects and links or creates or deletes graphical elements and links from the map 20, each action can be stored as encounter data 28 indicating a corresponding effect on the underlying health data objects and one or more relationships to other health data objects. In this way, each instance of manipulation or adjustment, creation or deletion of a graphical element or graphical connection between elements can be stored as part of the encounter data (e.g., log data) corresponding to the underlying health data objects and relationships represented thereby. The log data thus can be used to provide a detailed record of the decision making process. In this way, not only does the diagnostic mapping system 12 provide a visualization of a current (or historical) diagnosis and contributing factors (e.g., represented by the state of the graphical elements and connections), but it also can store the encounter data to record each intermediate step (corresponding to additions subtractions or changes) that occurred to arrive at such diagnosis.

The visualization engine 18 can also include a document generator 30 that is programmed to generate the encounter data 28 by capturing a process of clinical decision-making in response to each addition, subtraction or modification to the graphical elements and graphical connections in the graphical map 20. It is to be understood that some graphical elements displayed in the graphical map may not be associated or linked with other elements and that the document generator 30 can also store encounter data reflecting modifications or other graphical actions that are performed on such unassociated graphical elements.

By way of further example, the document generator 30 can include a coder 31 that is programmed to generate clinical codes and/or billing codes in response to each user graphical interaction with the system 12. For instance, when a diagnosis or supporting evidence is dragged onto another graphical element, the corresponding diagnosis engine 34 can execute a set of rules to acquire necessary information and details that may be required to comply with clinical and billing coding regulations or standards. The coder 31 can be implemented to be self-learning or infer codes for each diagnosis and user-interaction via the user controls 26. The coder 31 thus can generate corresponding codes and store such codes in the local storage 22 in response interactions entered by a user.

For example, the document generator 30 can store the encounter data using a variety of standard codes. Thus the coder can be programmed to generate corresponding codes according to the coding systems utilized by the healthcare enterprise using the system 10, such as diagnostic codes (e.g., ICD-10, ICD-9, ICPC-2 and the like), procedure codes (e.g., HCPCS CPT, ICD-10 PCS, ICD-9-CM and the like) pharmaceutical codes (ATC, NDC, DIN and the like), topographical codes, outcome codes (NOC) or other relevant codes, including known or yet to be developed coding systems. In this way, the rules can be programmed and executed by the document generator 30 to ensure that the most detailed code(s) for diagnosis and billing purposes can be generated.

In addition to generating codes, the document generator 30 can also construct other supporting evidence (e.g., severity information or the like) over a broad clinical spectrum that can be stored as part of the encounter data 28. The document generator 30, for example, can add such information to a patient encounter in response to user interactions with the graphical map (e.g., making and/or breaking links). Alternatively or additionally, the document generator 30 can be programmed to elicit such information from the user via corresponding user input GUI elements (e.g., presenting a text user-entry form or the like). Such a user input GUI element can be partially (or wholly) populated with information based on the graphical map (according to health data objects and the association data being represented), which pre-populated information can require validation by the user. Once such encounter data has been generated, including codes and related supporting evidence, the system 12 can employ the repository interface 14 to push the data to be stored in the EHR repository 16 such as for billing and/or clinical purposes.

The document generator 30 can also be utilized to create notes or other freeform entry of information (e.g., text, audio, or audio-video) that a user may enter into the system 10 via the corresponding user controls 26. Such notes or other information can be stored as part of the encounter data 28. The visualization engine 18 can send the encounter data 28 to the EHR repository via the repository interface 14 (e.g., via HL7 or other application layer protocol) to push back log data and notes data that may be stored as corresponding health data objects for a given patient encounter.

The document generator 30 can also be programmed to assemble or generate a user perceptible type of document (e.g., a report) based on the encounter data 28 that can be stored in the local storage 22. For example, the encounter data can be stored in a known format (e.g., XML), which the document generator 30 can utilize to create a corresponding user perceptible document (e.g., a PDF, a Microsoft Word document or the like). Such user perceptible document can be created based on metadata for links between the health data objects, corresponding to the graphical connections in the graphical map 20.

By way of further example, the document generator 30 can generate the document to include user perceptible representation of the health data objects for diagnostic concepts that are represented by the graphical elements in the graphical map 20. The document can also include health data objects for lab data as well as health data objects for interventions, which can be represented as graphical elements in the interactive graphical map 20. In this way, the document generator 30 can provide the encounter data in one or more forms, which may depend upon the EHR system and user requirements. The form may also be selected by the user via corresponding user controls 26. The corresponding user perceptible document can thus provide additional supporting proof of patient management and/or review of patient medical data that is recorded and logged as part of the encounter data in response to and corresponding to the user interactions with the graphical map 20.

The visualization engine 18 also includes a display control 32 that controls the graphical appearance of the graphical elements and graphical connections in the graphical map 20 based on the association data 24 and user data 40. The display control 32 can also control animation of elements and connections in the graphical map 20.

As an example, the display control 32 can operate in an animation mode to animate the graphical map for a given patient over a period of time based upon the health object data obtained from the EHR repository (corresponding to the graphical elements) and based on the association data 24 as a function of temporal data that is stored with the association data 24 and the health data objects. In this way, temporal changes in the interactive graphical map over one or more patient encounter can be visualized graphically to represent the medical decision making process over one or more selected periods of time for a given patient. For example, by entering such animation mode, the graphical map 20 can graphically re-create the decision making process for a given patient, such as based on the encounter data mentioned above. The animation and play back of the decision making process can help a reviewer (e.g., the user or a supervisor or team) better understand the underlying thought process and decisions made by the caregiver. The amount of time or patient encounters for which the animation is displayed for the graphical map 20 can be selected by a given user in response to a user input.

The visualization engine 18 can also include a diagnosis engine 34 to determine a diagnosis based on health objects retrieved from the repository 16 and local storage 22. For example, the diagnosis engine 34 can be programmed to generate the map or a portion thereof such that graphical connections between selected graphical elements in the interactive graphical map represent association data in relation to a one or more diagnosis relating to the health data objects.

The diagnosis engine can employ a rules engine that is programmed to evaluate the health data objects for a given patient by applying a set of predetermined rules. The rules can be based programmed a best practices approach or other criteria that may vary for a given application of the system 12. The diagnosis engine 34 can also graphically suggest an association as a suggested graphical connection between graphical elements corresponding to a given diagnostic relationship between a potentially related set of health data objects based on application of the rules to the health data objects represented by the graphical elements for a given patient encounter. A potentially related set of health data objects can comprise two or more health data objects for diagnostic concepts, health data objects for lab data, health data objects for interventions or other supporting evidence that may be entered into the system via the user controls 26 or obtained from the EHR repository 16 or another source (e.g., medical devices, monitoring equipment or the like) for a given patient. The diagnosis engine 34 can represent the relationship between two or more such potentially related health data objects as a graphical connection between such respective graphical elements for objects according to metadata that is stored as part of the association data 24.

A suggested graphical connection or suggested diagnosis can be implemented in a variety of forms, such as, for example, blinking, animation, dotted lines, different color graphics or other methods to differentiate the suggested link from an actual association that has been validated by a user. The suggested graphical link can remain differentiated from other graphical connections until validated or invalidated by a user. For example, a user can validate a suggested link or diagnosis by clicking on it or otherwise marking it via the user controls 26. Each interaction via the user controls 26, including for validating and invalidating new graphical elements or links between elements, can be recorded and stored as medical decision making information as part of the encounter data 28 as disclosed herein. In this way, such interactions by the user with the graphical map 20 can create a log of patient management and review of clinical data for a given patient that can be stored as the encounter data 28. As disclosed herein, the encounter data or a selected portion thereof can be pushed to the EHR repository 16 via the repository interface 14.

By way of further example, the visualization engine 18 can also include a health element generator 36 and a link generator 38. The health element generator 36 can be programmed to generate a new graphical element for a corresponding health data object for a given patient. The health element generator 36 can be programmed to generate the health data element as a potential element in response to an evaluation of supporting evidence and health data objects by the diagnosis engine 34. User controls 26 can be employed to validate a corresponding new suggested health data object represented by the graphical element on the map 20. The corresponding health data object for such graphical element can be provided to the EHR repository 16 via the repository interface 14.

The health element generator 36 can be programmed to automatically generate such health data elements based on the analysis of health data objects from the EHR repository 16 and association data 24 for the given patient. The generation of health data elements and links can be constrained to a current patient encounter or it may also encompass historical data for the patient. Such automatically generated health data elements can be graphically differentiated until validated or invalidated in response to a user input.

Alternatively or additionally, the health element generator 36 can be programmed to generate new graphical elements and corresponding health data objects in response to a user input via the user controls 26. Once such new elements are generated in response to user controls they can be automatically presumed to be validated (having been manually—not automatically—generated). The manually generated health elements can thus result in a corresponding health data object being created and stored in the encounter data 28 as well as being pushed to the EHR repository 16 for the patient encounter.

Similarly, the link generator 38 can be utilized to automatically create and/or suggest links between graphical health elements in the map to indicate an association or causal connection between corresponding health data objects and supporting evidence. For example, the diagnosis engine 34 can evaluate a set health data objects and supporting evidence for a given patient and based upon such analysis determine if potentially relevant associations exist. The link generator 38 thus can present the suggested link to the user as a graphical connection between graphical health elements in a graphically differentiated form until validated or invalidated by the user via the user controls 26. A user can also manually generate a link between health elements or destroy link between health elements via the user controls 26. Each interaction of generating or invalidating links between health elements can be recorded as part of the encounter data 28, which may also be pushed into the EHR repository 16, as disclosed herein.

The visualization system 10 can also employ user data 40 stored in the local storage 22. The user data 40 can store information relating to each authorized user of the system. For example, the user data 40 can include role data and preference data for each user. The role data can be stored in memory for each of the users and be utilized to vary or control the content and organization of the interactive graphical map 20 for a user based upon the role data. For example, each user can be assigned a given role, such as a physician, nurse, patient, or other technical professional and, depending upon the role, different types of information may be presented in a graphical map. In addition to different types of information, information may be presented in different ways depending upon the sophistication or technical expertise of the user defined by the role data. For example, more technical information may be provided for a physician than for a patient, which can also be a user. Additionally, different users at a given category may result in information being presented differently depending on each user's role data, such as identifying a particular interest or area of specialization. For example, a pulmonologist can have the graphical map 20 appear differently (with the same or different information) from the graphical map generated for the same patient where the user's role is defined a cardiologist. The visualization engine 18 can employ the display control 32 to flex or morph the graphical map 20 based on the role data for each respective user. Additionally, a greater level of authorization and access to different types of information can be provided based on the role data.

Preference data, which can also be stored in memory, can be utilized to set individual user preferences for the arrangement and structure of information that the visualization engine 18 presents in the interactive graphical map 20. For example, preference data can be set automatically by the diagnostic mapping system 12 based upon a given user's prior usage, which is stored as part the preference data. The display control 32 thus can select and control the graphical representation of health data objects for use in generating the interactive graphical map and arrange such graphical elements in the map for a given instance according to the user preference data of a given user that is currently logged into the system. The system 12 can learn preferences and how to arrange objects based upon repeated changes made by a given user. For example, the system 10 can infer or employ machine learning from log data that can be stored in memory in response to user interactions.

The user data 40 can also be utilized to establish access to the diagnostic mapping system 12 via a plurality of different types of devices, each of which may be presented the data differently, such as depending upon the display capabilities of such device. Each device can still employ the user controls 26 to generate new graphical elements, modify existing elements or to generate links or modify existing links in the graphical map 20. The manner in which such controls are implemented and accessed by a user can vary depending upon the device.

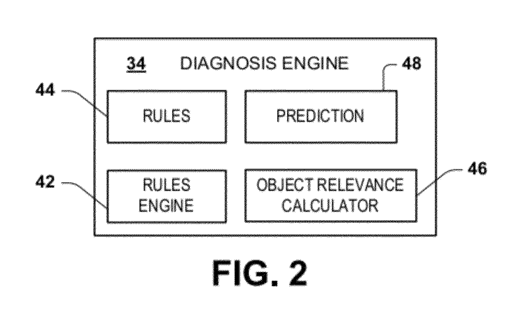

FIG. 2 depicts an example of a diagnosis engine 34 that can be implemented as part of the diagnostic mapping system 12 of FIG. 1. Accordingly, reference is made back to FIG. 1 for interrelationships between the function and methods of the diagnosis engine 34 and those disclosed with respect to FIG. 1. In the example of FIG. 2, the diagnosis engine 34 includes a rules engine 42 programmed to evaluate health data objects for a given patient and to determine relevance between health data objects. The rules engine 42 determines the relevance between objects based upon a set of one or more rules 44. The rules 44 can be a programmable data set that can be determined for a given practice or institution based upon best practices. The system can employ a default set of rules based upon national or local standards or as otherwise determined by the user or administrator. The rules can further be programmed to be user specific, such as can be selected according to user data, such as user preferences data and/or user profile data.

Additionally, the rules engine 42 can generate new rules which can be globally implemented within the system 12 or be user defined (e.g., part of the user data) to provide more flexibility to each user. For example, the rules engine 42 can learn and apply a unique set of rules for each user based on previous system usage data that can be stored in the user data 40.

The diagnosis engine 34 can also include an object relevance calculator 46 that can compute a confidence value indicative of how related the health data objects are. The object relevance calculator 46 can compute the relevance and provide the confidence value based upon the association data or metadata that is provided with the respect of health data objects. The relevance between health data objects thus can be stored as relevance data as part of the association data 24 (FIG. 1). The display control 32 thus can employ the relevance data to control the relative position and orientation as well as other display parameters of the graphical elements and links based upon the relevance data. For example, a more highly related set of graphical elements can be presented in closer proximity to each other, thereby providing an indication of a high level of relevance there between such objects. In contrast, objects that are determined to have a relatively lower amount of relevance yet still be associated with one another can be represented by a longer graphical connection or otherwise (e.g., smaller size, presented further in background in a three-dimensional display or the like).

In addition to the rules engine 42 being applied to new health data objects, the rules engine 42 can be programmed to analyze health data objects and links between health data objects in the graphical map 20 in response to user manipulation or modification thereof. That is, the rules engine 42 can reapply relevant rules 44 to evaluate an existing set of elements in the graphical map following changes in links and other metadata that may be effected in response to the user manipulation via the user controls. This can be done to suggest additional links or perhaps suggest additional health data objects that may be determined to be pertinent based upon the aggregate set of health data objects represented by elements in the graphical map 20.

The diagnosis engine 34 can also employ rules to obtain additional information related to a given diagnosis. Examples of cascading logic that can be utilized as rules for generating diagnoses are shown in Appendix A.

Additionally, the rules engine 42 can learn new associations between graphical elements and store such as new diagnosis rules in the rule set 44, such as in response to user validation or creation of a diagnosis data element and its association with supporting evidence data elements on the interactive graphical map.

The diagnosis engine 34 can also include a prediction function 48 that can be programmed (e.g., with a predictive model) to predict a likelihood of a patient's outcome, such as a diagnosis, length of stay, readmission risk, patient satisfaction or other outcomes for a patient or group of patients. In addition to predicting patient outcomes, the prediction function 48 can be utilized to generate a prediction for administrative conditions. Administrative conditions can include quantifiable information about various parts of a facility or institution, such as admissions, capacity, scheduled surgery, number of open beds or other conditions that may be monitored by administrative personnel or executive staff. The type of prediction algorithms and models that can be utilized can vary according to the type of condition or outcome being predicted and the type of information to be presented by the diagnostic mapping system 12. One example of a prediction model that can be utilized is disclosed in U.S. patent application Ser. No. 13/451,984, filed Apr. 20, 2012, and entitled PREDICTIVE MODELING, which is incorporated herein by reference.

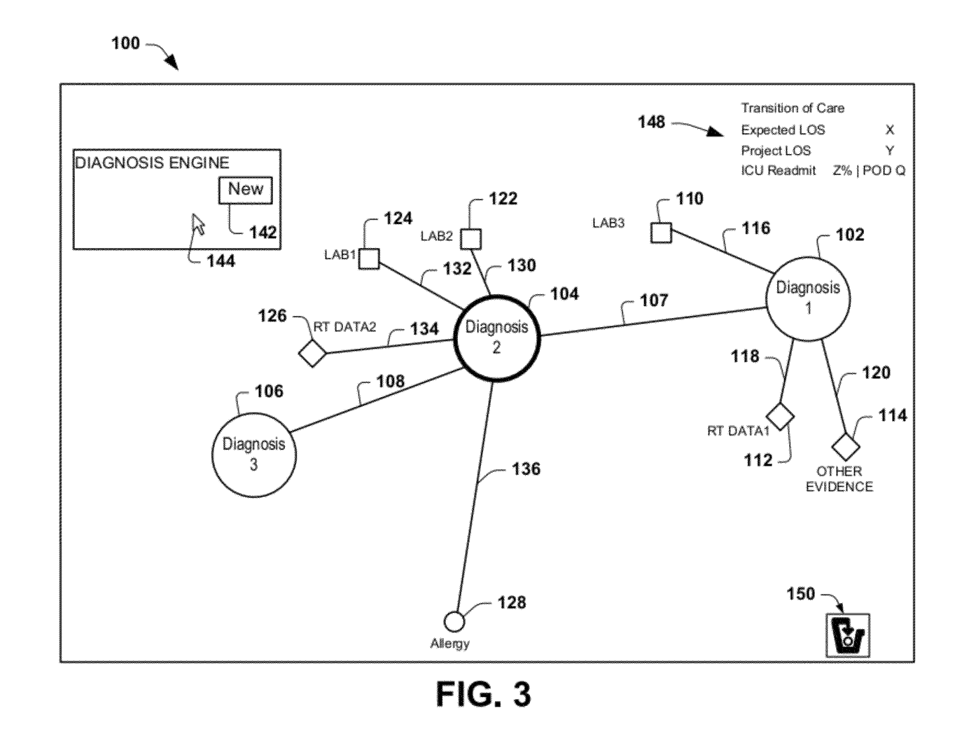

In view of the foregoing examples of FIGS. 1 and 2, the following examples of FIGS. 3 through 19 will be utilized to demonstrate examples of interactive graphical maps that can be implemented according to this disclosure.

FIGS. 3 through 5 demonstrate an example of an interactive graphical map 100 representing a set of diagnoses and supporting evidence. In this example, the interactive graphical map 100 includes three diagnosis elements 102, 104 and 106, demonstrated as Diagnosis 1, Diagnosis 2, and Diagnosis 3, respectively. Diagnosis 1 is associated with Diagnosis 2, which association is represented as a graphical connection 107. Diagnosis 3 is associated with Diagnosis 2 as represented by graphical connection 108. As disclosed herein, each of the graphical connections 116, 118 and 120 can be generated manually in response to a user input or has been suggested and validated by a user via corresponding user controls the association represented by such graphical connections can be stored in local storage as association data (e.g., link data and relevance data in association data 24 of FIG. 1).

Diagnosis 1 is demonstrated as being supported by supporting evidence (e.g., health data objects) represented in the map 100 by graphical elements 110, 112 and 114. For instance, element 110 corresponds to lab results (Lab 3) and is associated with Diagnosis 1 via graphical connection 116. Supporting evidence graphical element 112 is demonstrated as Real Time Data 1 (RT Data 1) and is associated with Diagnosis 1 via graphical connection 118. The OTHER EVIDENCE graphical element 114 is also associated with Diagnosis 1 102 via the graphical connection 120. As disclosed herein, each of the graphical elements 110, 112 and 114 can correspond to health data objects, such as can be stored in an EHR repository and/or in local storage.

Similarly, Diagnosis 2 is demonstrated in the example of FIG. 3 as being supported by supported evidence graphical evidence elements 122, 124, 126 and 128 via corresponding graphical connections 130, 132, 134 and 136. In the example of FIG. 3, the length (and/or other parameters) of the respective graphical connections can be utilized to indicate the confidence or relevance value between the supporting evidence and the underlying diagnosis supported thereby. Additionally, Diagnosis 2 is demonstrated as having a bolder perimeter to demonstrate, for example, the underlying severity of such diagnosis and importance thereof relative to the other diagnosis represented by graphical elements 102 and 106. Other types of differentiators can also be utilized. The graphical differentiation between the diagnosis graphical elements 102, 104 and 106 can be based on relevance data (e.g., part of association data 24 of FIG. 1), for example.

The graphical map 100 also includes a diagnosis engine user interface element 140. The diagnosis engine 140 can be utilized by a user to create new links or diagnoses, such as in response to activating a NEW user interface element 142. For instance, a user can employ a pointing element 144 to activate the user interface element 142. Additionally, additional modifications can be made to the interactive graphical map via the pointing element or via other means which may vary depending upon the type of user device. For instance, elements can be accessed and manipulated via touch screen, keyboard or other unit input devices. A set of predicted results can also be generated and displayed in the interactive graphical map, as demonstrated at 148, based on applying corresponding predictive models to the health data objects represented in the graphical map 100. In the example of FIG. 3, the predicted outcomes 148 are demonstrated as an expected length of stay, a projected length of stay, an ICU readmission rate and post-operative days.

As disclosed herein, in addition to adding elements to the map 100 a user can also remove graphical elements and connections via corresponding user controls. For example, a link or element can be deleted by dragging it into a trash user interface element 150. Those skilled in the art will understand and appreciate that other mechanisms can be utilized for deleting such as highlighting and clicking on the object and providing a corresponding drop-down menu or highlighting an object by clicking on it and then deleting it via a delete key on the keyboard.

Also as shown in FIG. 3, different supporting graphical elements can have different shapes or otherwise be represented differently depending upon the type of data and evidence or information being represented thereby. In the particular example of FIG. 3, a rectangle corresponds to lab results, a diamond represents real time data or other evidence and a circle can represent a known relevant patient condition, such as an allergy to a specific medication or the like.

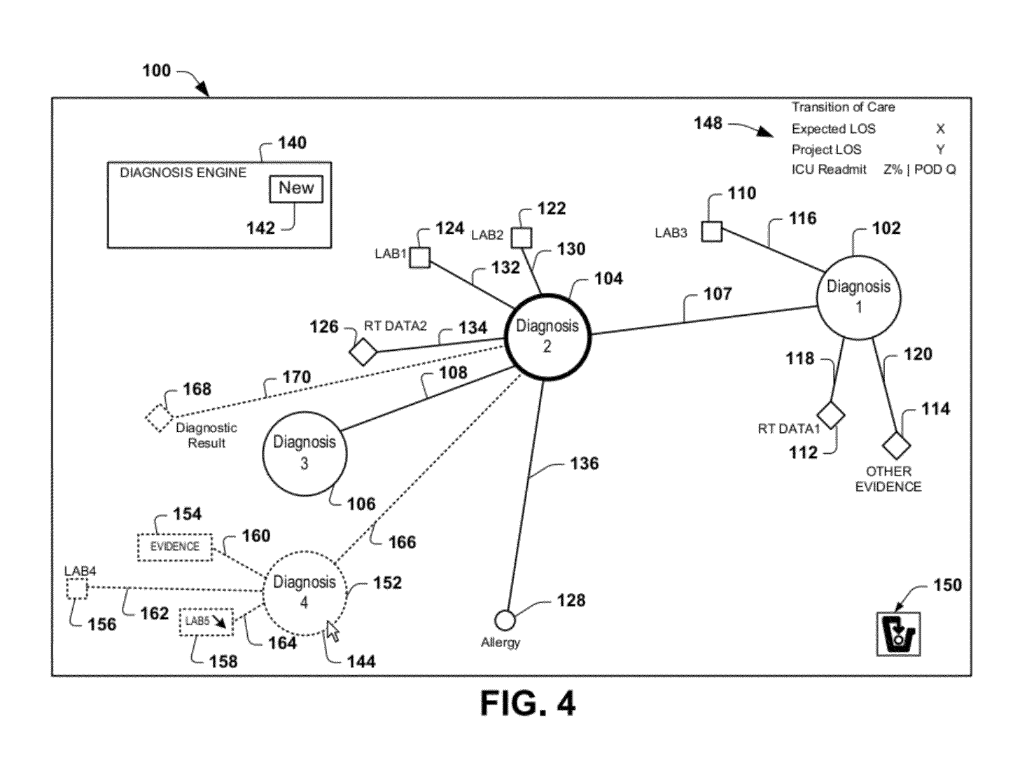

FIG. 4 depicts an example of the interactive graphical map 100 in which the diagnosis engine (e.g., the diagnosis engine 34 of FIG. 1) has populated the graphical map 100 with an additional suggested set of graphical elements and suggested connections based upon new data that may have been obtained by the system, such as from EHR repository or other data sources (e.g., devices) to which the system can be connected. In the example of FIG. 4, the visualization engine has populated the graphical map with a suggested graphical element 152. The diagnosis engine has also provided suggested supporting graphical elements 154, 156 and 158 and has suggested associations between such elements and the underlying diagnosis represented by graphical element 152 via graphical connections 160, 162 and 164.

By way of example, suggested graphical elements and suggested links are demonstrated in the example of FIG. 4 by dotted lines. It is to be understood and appreciated that such suggestions can be represented in the graphical map differently in other examples. An association between Diagnosis 4 and Diagnosis 2 has been suggested by graphical link 166 connecting graphical elements 104 and 152. The diagnostic engine has also suggested an association between a new diagnostic result (represented by graphical element 168) via an association 170 with the underlying Diagnosis 2 represented by graphical element 104.

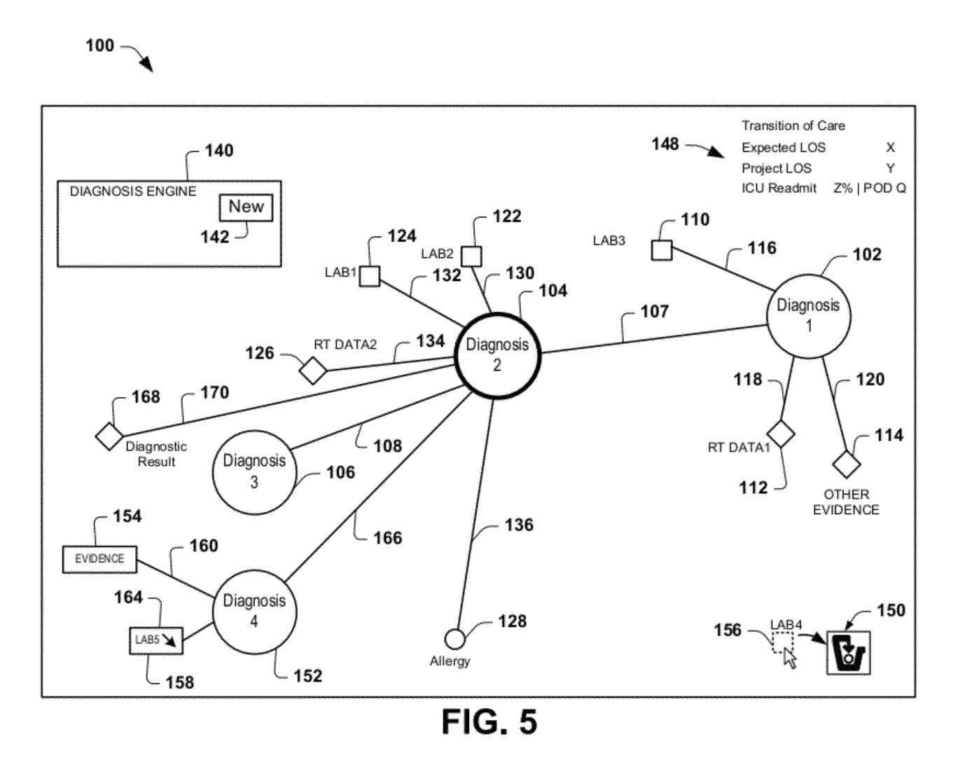

As disclosed herein, a user can validate or invalidate each suggested piece of supporting evidence (graphical elements) and each association (connections) presented in the interactive graphical map 100, such as via user controls that can be accessed via the pointing element 144 or other user input mechanisms. Thus, in the example of FIG. 5, the causal link represented by graphical connection 160 between supporting evidence, corresponding to graphical element 154, and Diagnosis 4 represented by graphical element 152 has been validated. The association corresponding to graphical connection 166 as well as the association represented by graphical connection 170 between the diagnostic result element 168 and the Diagnosis 2 represented by graphical element 104 have also been validated, and are thus shown in solid lines. However, in the example of FIG. 5, the lab 4 which had been suggested to be associated with Diagnosis 4 via graphical connection 162 is being invalidated, such as in response to the user dragging and dropping the graphical element 156 into the trash user interface element 150. In this way, a suggested or actual diagnosis as well as suggested or actual evidence determined by the user as not relevant (e.g., contributing) to a given diagnosis can be discarded by the user. As disclosed herein, each action whether a validation, invalidation or manipulation of the graphical map 100 can be stored as part of the encounter data in local storage as well as can be provided to the EHR repository for documenting the medical decision making process. Such user interactions can also result in corresponding coding be generated (e.g., via coder 31 of FIG. 1).

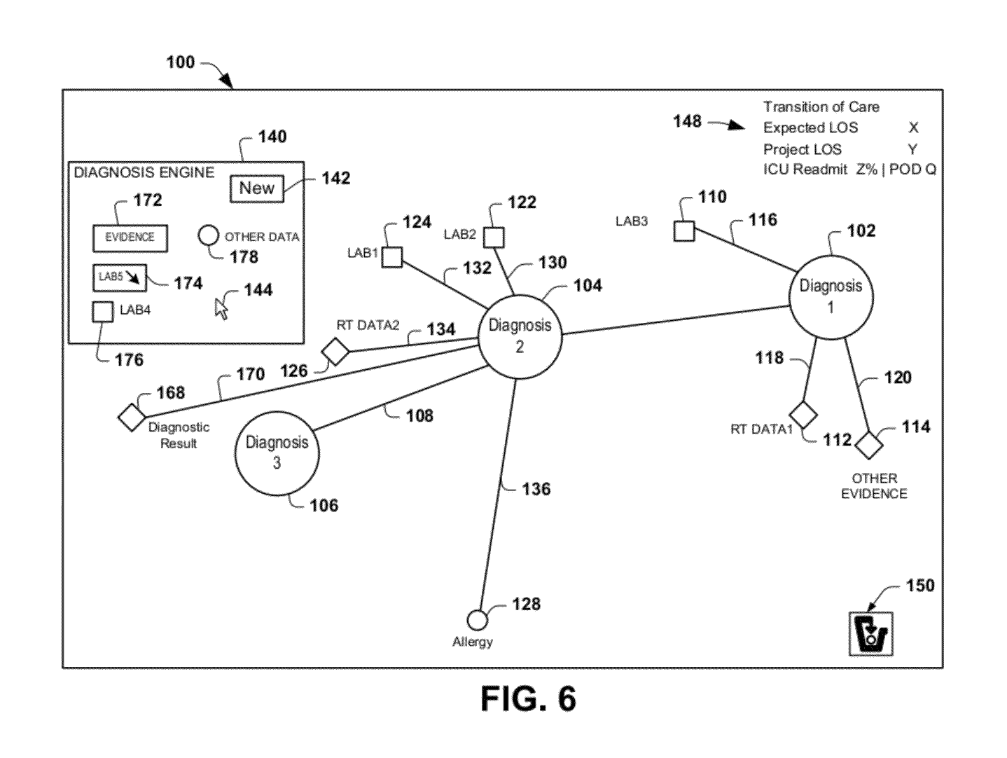

FIG. 6 demonstrates another example of the interactive graphical map 100 that is similar to the example of FIG. 4. However in the example of FIG. 6, instead of the diagnosis engine automatically populating the workspace of the interactive map 100 with graphical elements for new information, a set of graphical elements 172, 174, 176 and 178 are presented in the diagnosis engine graphical user interface (GUI) element 140 as being unassociated with any existing or new diagnosis. A user thus can employ the pointing element 144 to drop each of these new graphical elements 172, 174, 176 and 178 onto the active workspace and associate them with existing diagnoses represented by graphical elements 102, 104, 106 or otherwise discard the graphical elements via the trash user interface element 150 as may be decided as appropriate by the user.

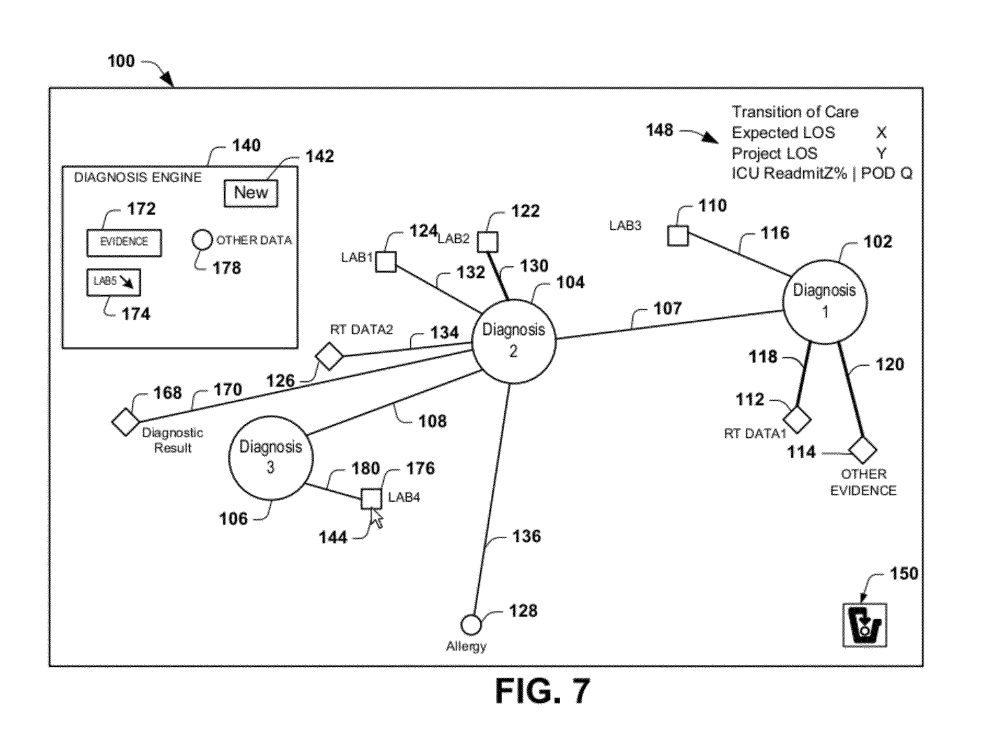

The example of FIG. 7 demonstrates a part of such a process in which some of the lab results, Lab 4, have been associated with Diagnosis 3 via a graphical connection 180. For example, a user can drag the graphical element 176 onto the graphical element 106 to create the association that results in the corresponding association data being stored in memory. A user can also identify the relevance of the association when being made manually by adjusting the length of the graphical connection 180, such as by adjusting the relative position of the associated graphical elements 106 and 176. Additionally or alternatively, a user can right click on the graphical connection 180 and enter a corresponding relevance or confidence value to indicate a strength of such association. Each such action, including an indication of the relevance that is set by the user, can be stored as part of the association data as well as encounter data. The encounter data further can be pushed back to the EHR repository by the system for documenting the medical decision-making process. Similar actions can be taken with respect to the other graphical elements 172, 174 and 178, such as by either associating them with an existing diagnosis that is presented on the interactive graphical map 100 or discarding of the evidence as not being relevant.

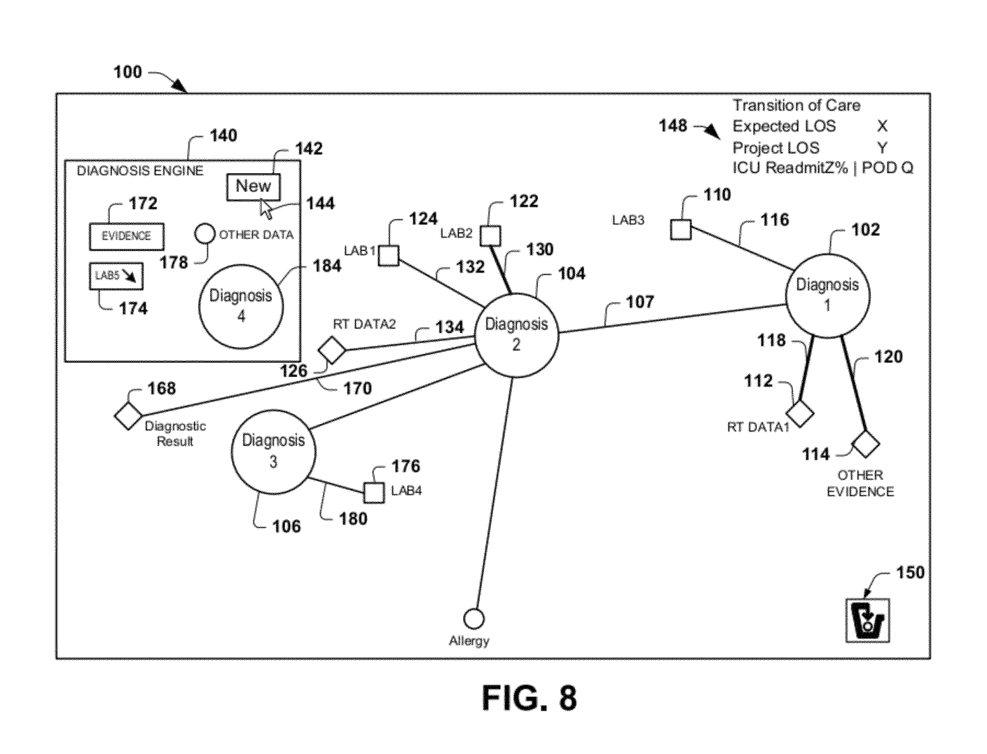

Additionally, as shown in the example of FIG. 8, a user can create a new diagnosis such as by activating the new user interface element 142 via a pointing element or other means of activating the user interface element. As shown in the example of FIG. 8, in response to activating the new user interface element 142, a new graphical element 184 can be presented on the interactive graphical map 100. The graphical element corresponding to Diagnosis 4 can be presented, for example within the diagnosis engine 140 or it can be automatically populated to the workspace in a free or unobstructed area. If the interactive graphical map is crowded, display controls can adjust the relative position to facilitate the addition of the new graphical element 184. By way of further example, in response to activating the new diagnosis user interface element 142 a user can be provided of potential diagnosis such as can be created by the diagnosis engine based upon health data objects for a given patient or a user may select to create a new diagnosis that results in a corresponding graphical element being generated onto the interactive graphical map.

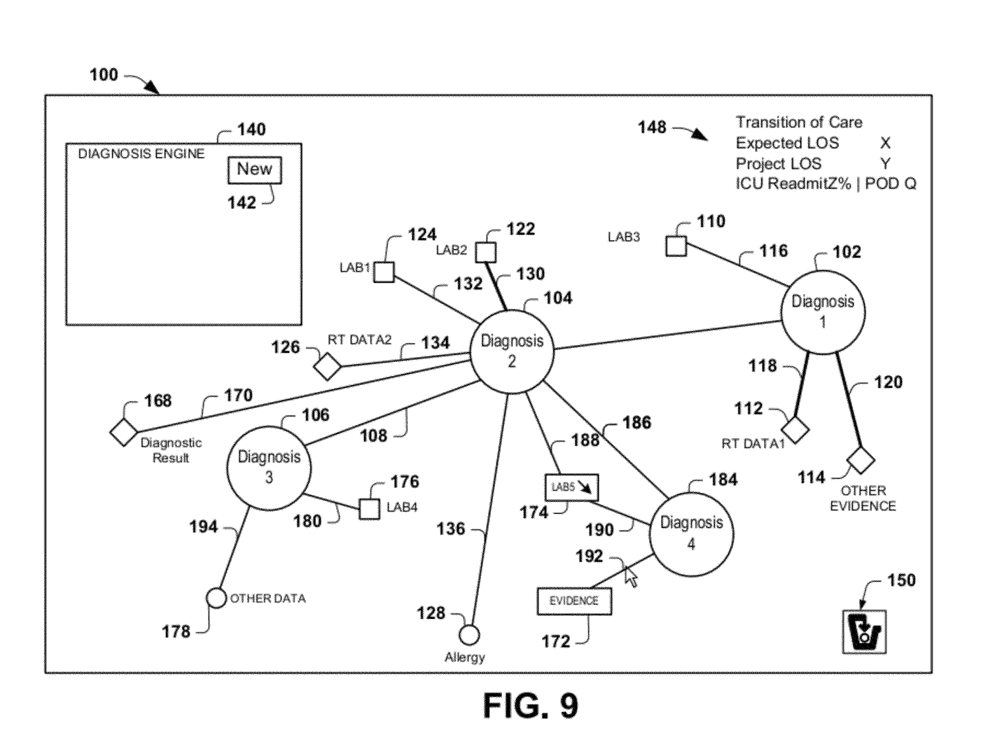

In the example of FIG. 9, the new diagnosis 184 and the related evidence has been added to the interactive graphical map workspace and associated in response to user inputs, such as by dragging and dropping each of the graphical elements onto another graphical element to which it is to be associated. For example, Diagnosis 4 can be associated with Diagnosis 2 by dragging and dropping the graphical element 184 onto graphical element 104 resulting in the corresponding association being generated at 186. Graphical element 174 (corresponding to Lab 5 indicating a downward trend in lab results) can be associated with Diagnosis 2 and Diagnosis 4 via dragging and dropping the graphical element 174 onto graphical element 104 and 184 resulting in respective graphical connections 188 and 190 being generated there between. Similarly evidence represented by graphical element 172 can be associated with Diagnosis 4 via dragging and dropping the evidence graphical element 172 onto element 184 resulting in graphical connection 192. Additionally, in example of FIG. 9, the OTHER DATA graphical element 178 that was not automatically associated with one of the diagnosis has been associated with Diagnosis 3 as represented by graphical connection 194. As disclosed herein, each manipulation and association made by a user (e.g., by dragging and dropping elements onto each other) or disposing of them via the trash user interface element 150 are recorded and stored as encounter data which further can be pushed back to the EHR repository utilizing appropriate coding techniques and data formats.

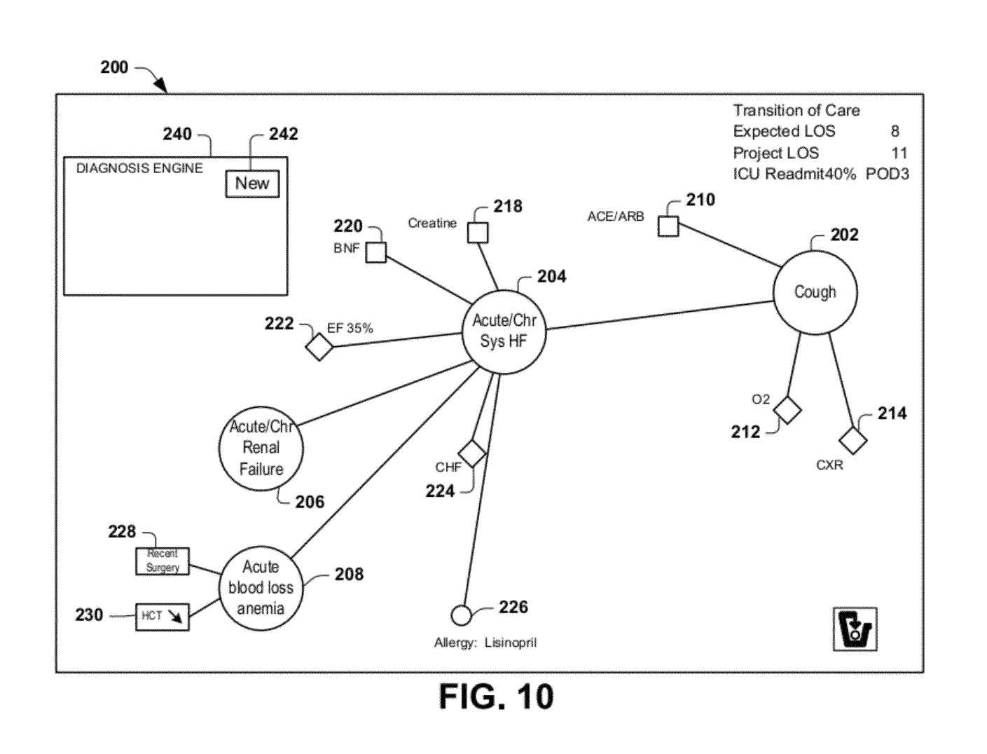

FIGS. 10, 11, 12 and 13 provide additional examples and context in which an interactive graphical map 200 can be utilized for diagnostic examples. In the example of FIG. 10, the interactive graphical map 200 displays graphical elements 202, 204, 206 and 208 corresponding diagnoses for cough, acute chronic systolic heart failure, acute chronic renal failure and acute blood loss anemia, respectively. In this example, the cough diagnosis represented by graphical element 202 is supported by medications ACE/ARB, oxygen level and a chest x-ray represented in the map 200 via graphical elements 210, 212, and 214, respectively. The graphical element 216 associated with the chest x-ray (CXR) can be activated to retrieve the actual chest x-ray. Each of the other elements can also be hovered over or otherwise activated to provide additional information associated with them which information can be obtained from metadata that is stored locally as part of the association data as well as health data objects that are obtained from the EHR repository.

Similarly, the acute chronic systolic heart failure diagnosis (represented by graphical element 204) is supported by evidentiary health data, which are represented in this example as including a creatine graphical element 218, a B-type Natriuretic Peptide (BNP) graphical element 220, an ejection fraction graphical element 222 and a congestive heart failure graphical element 224. Also associated with the diagnosis element 204 is an allergy interface element 226 demonstrating an allergy to a given medication, in this example Lisinopril.

A diagnosis can also provide supporting evidence or otherwise be associated with another diagnosis. In this example, acute chronic renal failure is supported or supports the acute chronic systolic heart failure diagnosis, which association is demonstrated by a corresponding graphical connection. The acute blood loss anemia diagnosis (represented by graphical element 208) is also associated with the element 204. Supporting evidence for the acute blood loss anemia diagnosis is provided via a recent surgery graphical element 228 and lab results, corresponding to a hematocrit and a graphical indication of trending downward, via graphical element 230.

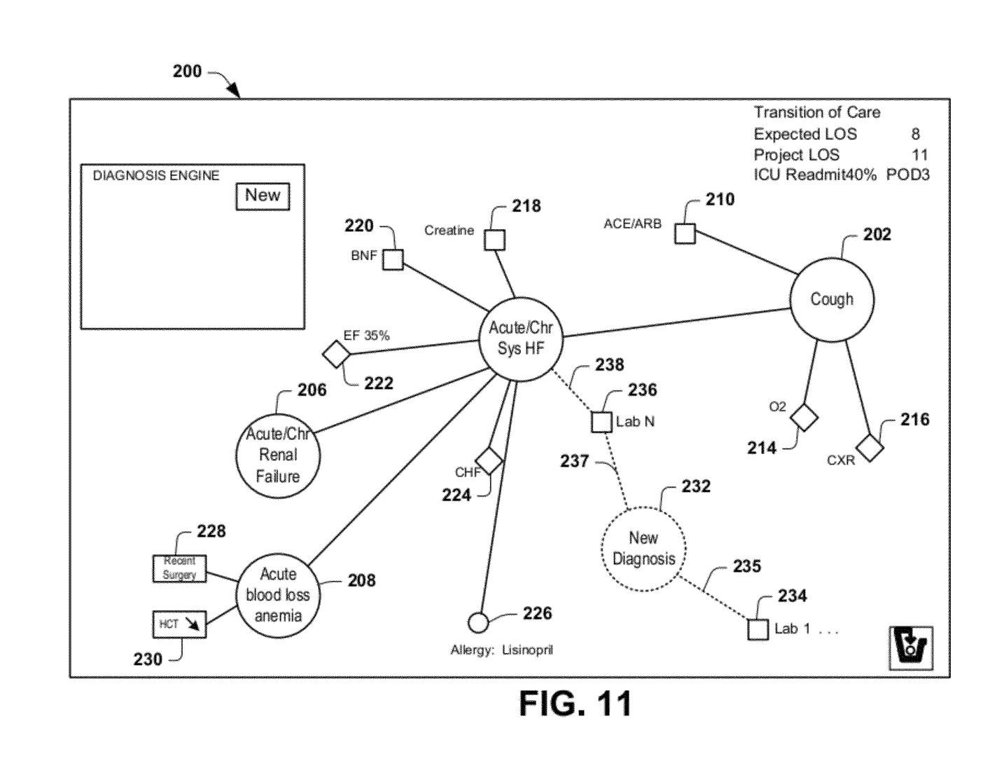

Also demonstrated in the example of FIG. 11 is a new diagnosis graphical element 232, such as can be any diagnosis relevant to a patient's condition. The new diagnosis can be determined by a diagnosis engine based on patient data stored in an EHR, as disclosed herein, for example. In this example, the new diagnosis 232 is a suggested diagnosis as indicated by its differentiated representation via the dotted lines. The new diagnosis is further suggested to be supported by lab results, indicated at Lab 1 and Lab N, via graphical elements 234 and 236. A suggested association and/or computed relevance of the Lab N results is also suggested with the diagnosis for acute chronic systolic heart failure diagnosis (represented by graphical element 204) via a suggested graphical connection 238. Thus, as disclosed herein, a given health data object can be associated with more than one diagnosis.

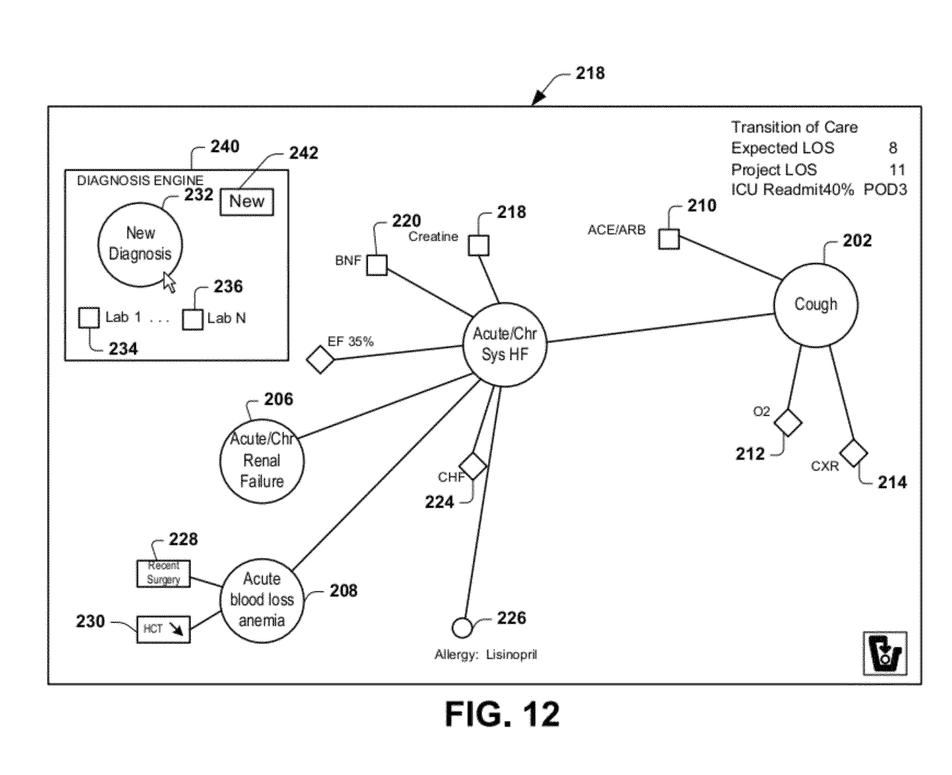

Similar to the example shown and described with respect to FIGS. 3-5, the suggested new diagnosis 232 and the related associations via graphical connections 235 and 237 can be automatically added to the interactive graphical map 200 via the diagnosis engine. Alternatively, as shown in the example of FIG. 12, graphical elements 232, 234 and 236 for the new diagnosis and corresponding lab results relating to new information and labs performed for a given patient can be presented in an unassociated manner such as part of a diagnosis engine user interface element 240. Similar to as shown and described herein with respect to FIGS. 6-9, the new patient information represented by graphical elements 232, 234 and 236 in FIG. 12 can be associated with other diagnoses or problems represented in the interactive graphical map 200. For example, a user can drag and drop elements from the diagnosis engine user interface 240 onto one or more other graphical elements to create a corresponding association that will be represented by a corresponding graphical connection.

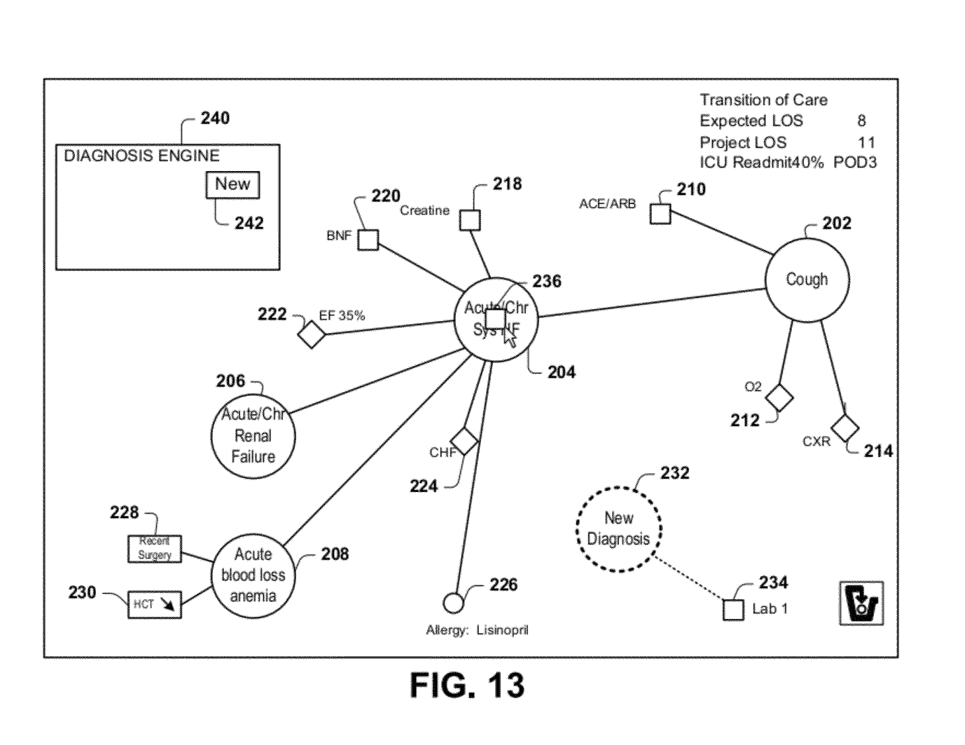

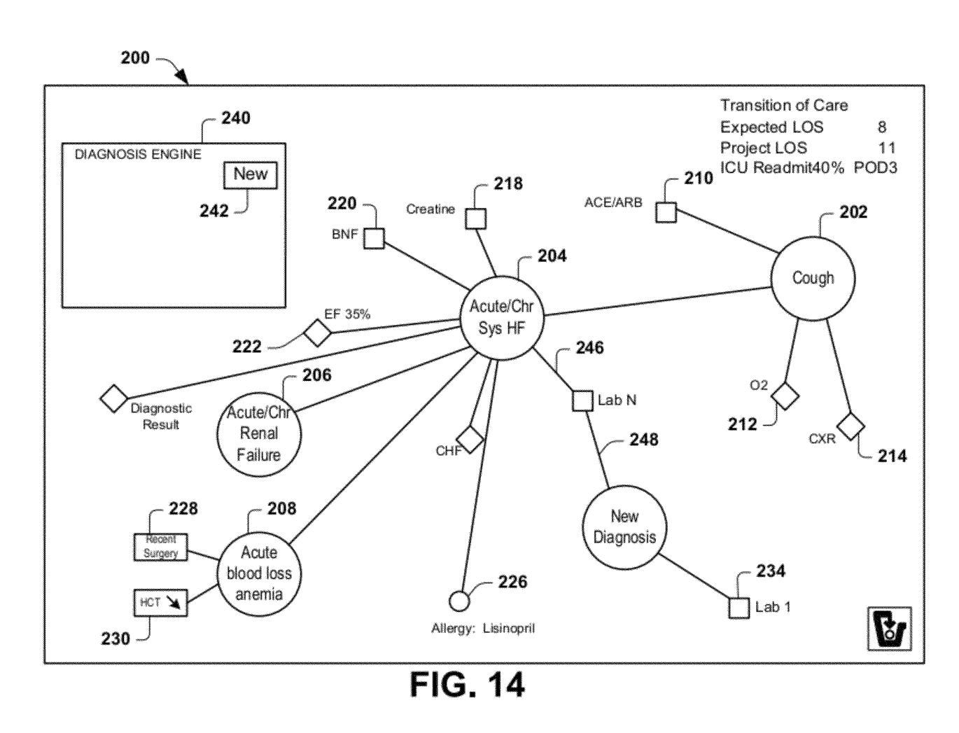

As shown in the example of FIG. 13, the Lab N results (represented by interactive graphical element 236) can be dragged and dropped onto the acute chronic systolic heart failure graphical element 204 to create a corresponding association as demonstrated via the association in FIG. 14 at 246. The new diagnosis can also be associated with Lab 1 results in a similar manner such as by dragging and dropping the Lab 1 graphical element 234 onto the new diagnosis element 232. As shown in the example of FIG. 14, supporting evidence patient data can be utilized and associated with more than one diagnosis. For instance, Lab N is demonstrated as relevant to and associated with both acute chronic systolic heart failure as well as the new diagnosis via associations 246 and 248, respectively.

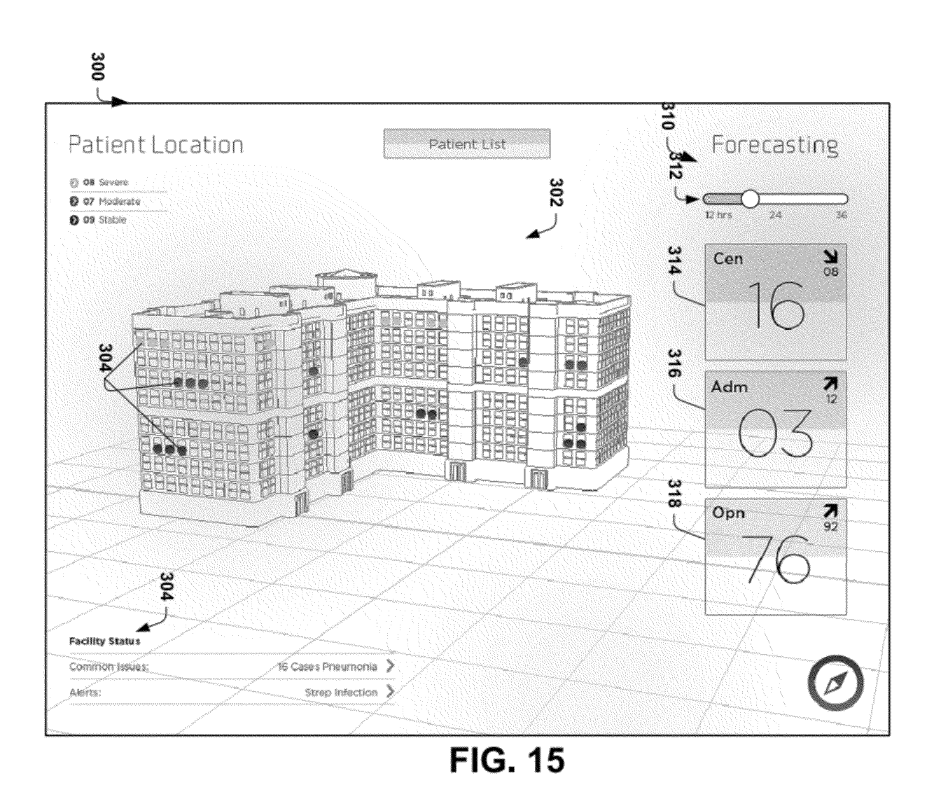

FIG. 15 illustrates an example embodiment of an interactive graphical map 300. The graphical map 300 includes a three-dimensional representation of a facility 302. The map also includes graphical representations of patients and corresponding status indicators (e.g., severe, moderate and stable) as indicated by icons 306 distributed throughout the facility representation 302. The interactive map 300 also includes a facility status indication user interface element 304 that displays general status information at a high level for the facility 302.

Some common issues can be presented in a summary manner. For example, information describing a number of cases of pneumonia and alerts can be represented in the map, such as strep infection. Each of these indications can be drilled down to obtain more detailed information, such as by clicking on or otherwise activating the corresponding user interface element. Similarly detailed information about each of the patients identified by the respective icons in the facility map 302 can be accessed by activating the respective patient icons 306.

The interactive graphical map 300 can also include a forecasting user interface element 310. The forecasting user interface element can employ one or more prediction functions, such as to forecast or predict conditions associated with the facility. A graphical slide or other like interface element 312 can be provided to selectively adjust the time period for which each prediction is computed, demonstrated in this example as ranging between twelve and thirty-six hours. Other types of ranges and timeframes can also be utilized for forecasting.

Additional facility indicators can also be provided at 314, 316 and 318. For example, indicator 314 can provide a graphical user interface element providing information about patient census information (CEN) and an indication of which way such parameters is trending. Element 316 can provide information about admissions (ADM) over the forecast period and as well as indicate a current trend in such parameter. The user interface element 318 can provide information about open beds (OPN) in the facility as well as indicate current trends associated with the number of open beds. A PATIENT LIST user interface element 320 can also be provided to represent specific information about the patients in the facility which further may be drilled down upon as shown and described herein.

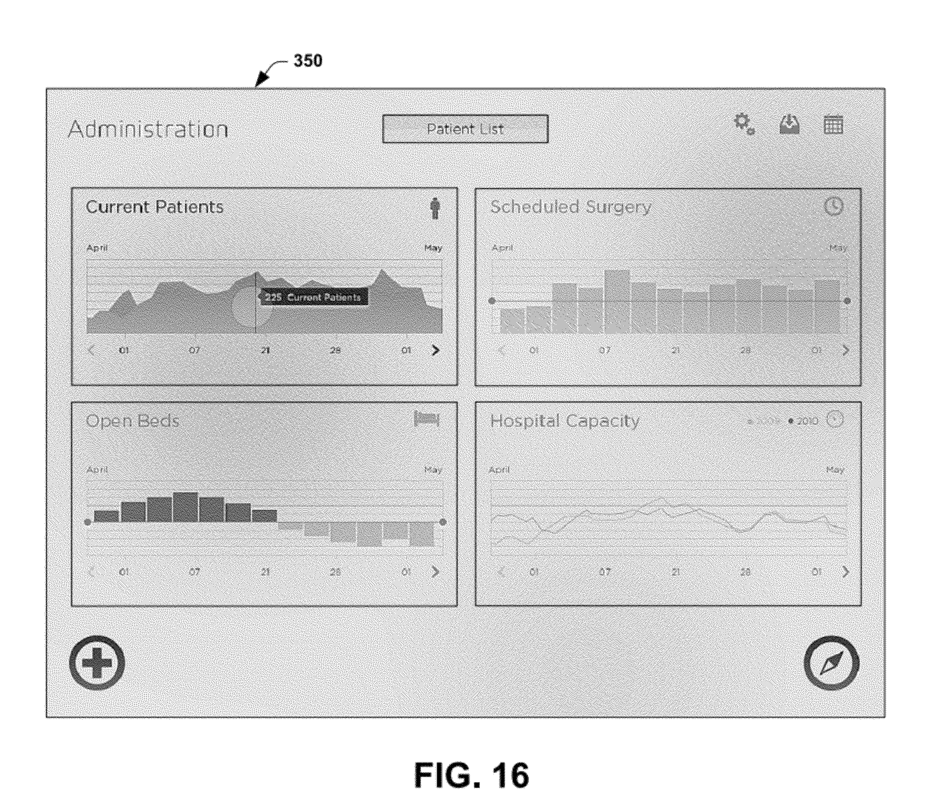

FIG. 16 illustrates an example of administration user interface screen 350. The administration user interface screen can provide dash-boarding of relevant information to an authorized user, such as an administrator or executive. In the example of FIG. 16, the administration screen 350 includes graphs demonstrating a selected set of facilitate administration parameters, including the current number of patients, open beds, scheduled surgeries as well as hospital capacity over selected time periods. This time period can be adjusted by the user via corresponding user controls.

Information in the administration screen 350 can be based upon historical data as well as scheduling information that can be stored in associated scheduling system accessible by the systems and methods shown and described herein. In addition to displaying plots of selected information, a timeline or caliber can be provided that can be moved across a given dashboard element to provide information for such selected time period. Additionally, predicted information can also be displayed for each of the dashboard elements. A user can also modify what information is presented in the screen 350 via corresponding selection user interface elements.

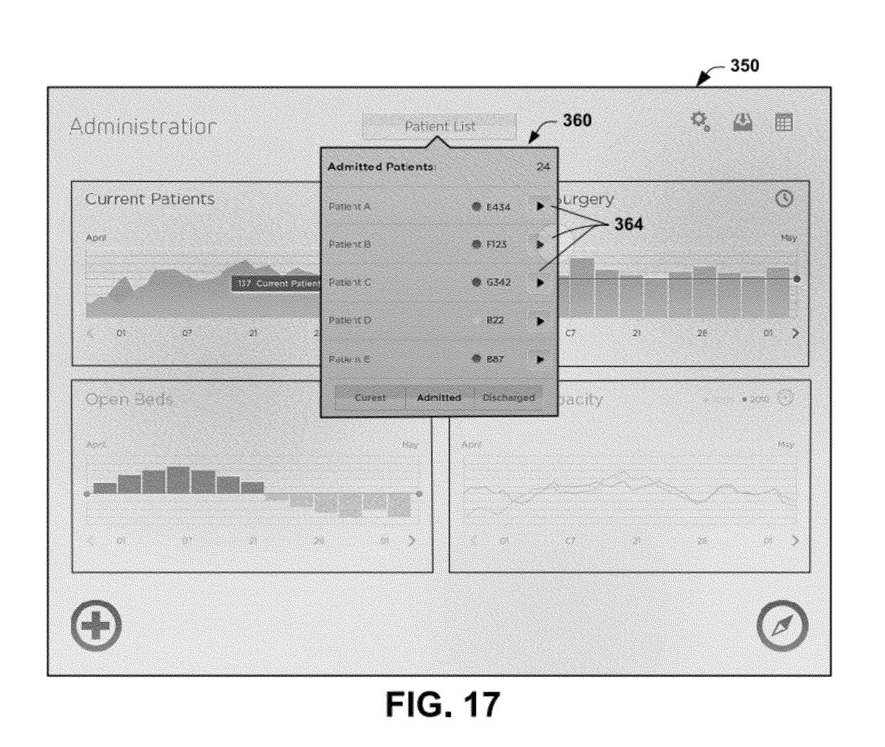

FIG. 17 demonstrates an example of a patient list user interface element, such as can be activated from the dashboard screen 350. The patient list user interface element 360 can result in a drop-down menu or other type of graphical user interface being superimposed on the dashboard screen 350. In the example of FIG. 17, the user interface element 360 presents a list of current patients or a selected subset thereof. Additional more general information, such as indicating the number of patients that may be in the facility, can also be provided as part of the user interface 360. Further detailed information can be provided for each patient via associated selector buttons 364. The patient list GUI can further allow a user to see similar types of information about current admitted patients as well as discharged patients.

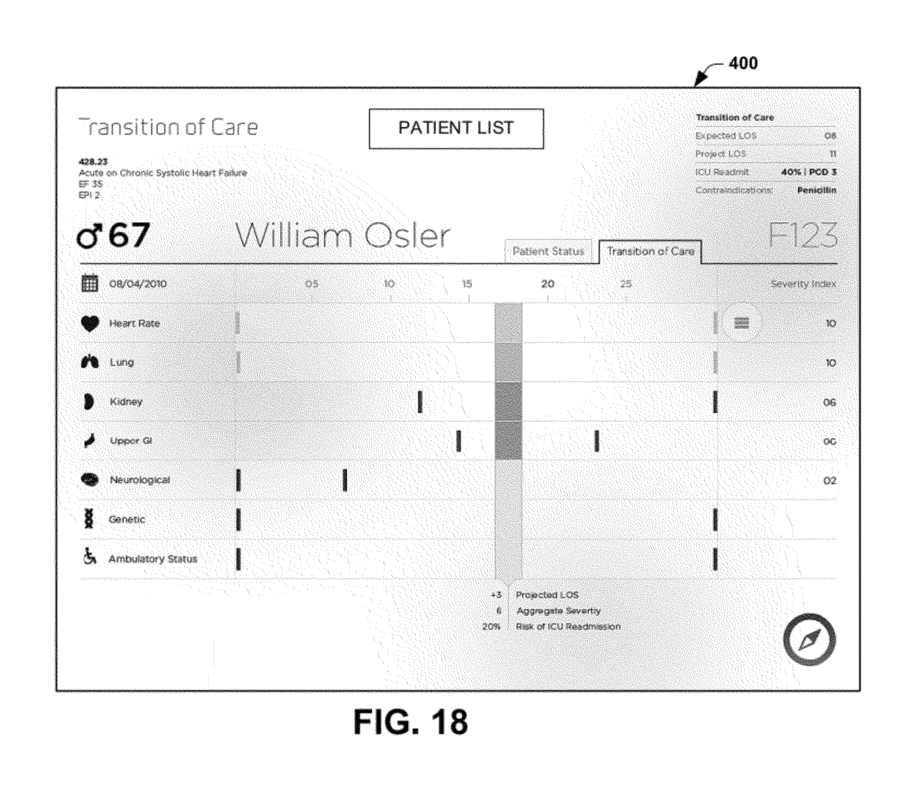

FIG. 18 depicts an example of a transition of care user interface screen 400 for a selected patient (William Osler), such as can be selected from the patient list user interface 360 of FIG. 17 or from other related mechanisms. The transition of care GUI 400 can be programmed to present information to the user, which may depend on user data, such as role data and preference data mentioned above. The transition of care GUI 400 thus can provide information over one or more periods of time (e.g., for one more patient encounter) which may be selected by the user via an associated user interface element.

In the example of FIG. 18 the transition of care user GUI 400 displays health information pertaining to the patient's heart rate, lungs, kidneys, upper GI, neurological, genetic and ambulatory status. For each such health parameter a severity index can be calculated and also displayed to the user in the GUI 400.

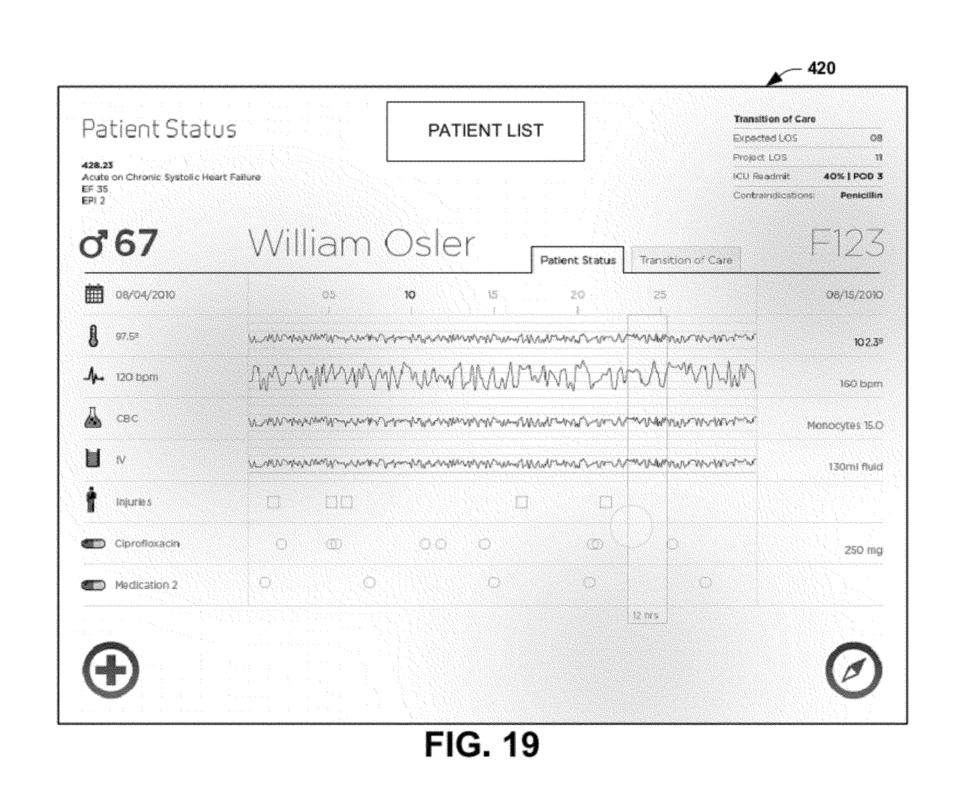

The system can also provide a patient status GUI screen 420. The patient status GUI 420 can provide current information and/or historic information for the user. The patient status GUI 420 can be displayed (e.g., graphically and/or via text) in relation to appropriate icons or other graphical indictors representing a selected set of parameters being monitored for the respective patient. In the example of FIG. 19, the information can include temperature, heart rate as well as lab results such as CBC, IV as well as an indication of injuries and medications that are taken.

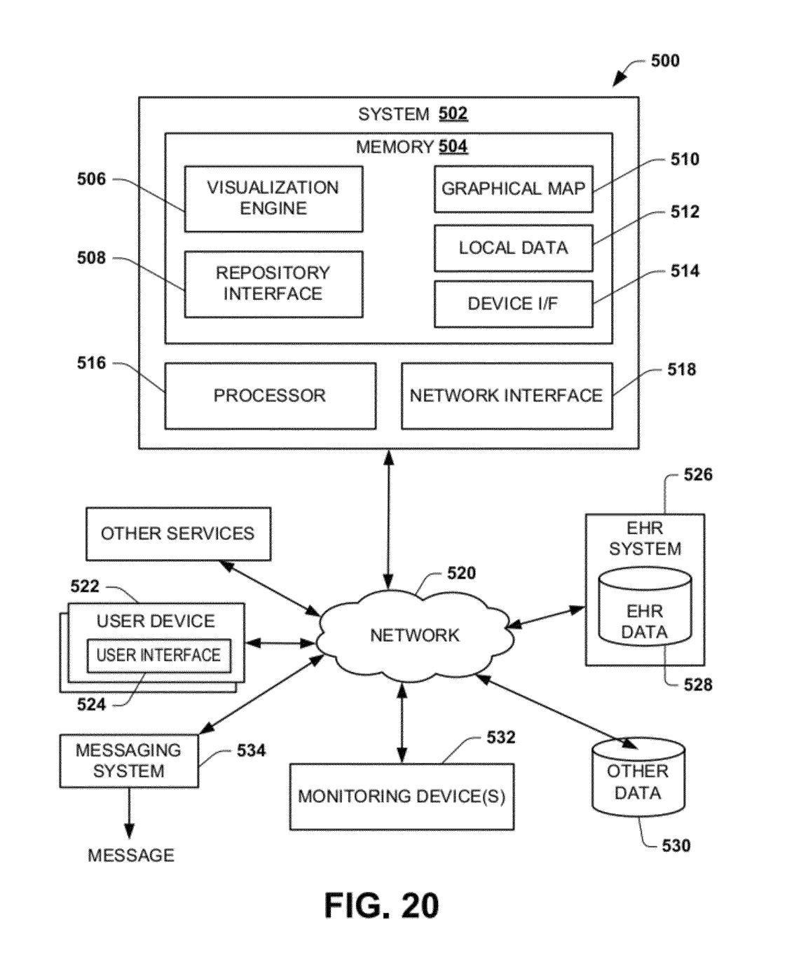

FIG. 20 depicts an example of a system architecture 500 in which the visualization system 502 can be implemented. In the example of FIG. 20, the system 502 includes a memory 504 that includes machine readable instructions and data that can be utilized by the system for implementing the functions and methods shown and described herein. For simplicity of explanation, the memory is 504 is depicted in FIG. 20 as including a visualization engine 506, a repository interface 508, an interactive graphical map 510, local data 512 and a device interface 514. The system 502 also includes one or more processors 516 that can access the memory 504 and execute the associated instructions and utilize the data. The system 502 can also include a network interface 518 that can be utilized to access corresponding network 520. The network can be implemented as including one or more local area network (LAN) or wide area network (WAN) or a combination of various networks. The network 520 may include wireless technology, fiber optic or electrically conductive medium for data communication.

The architecture 500 also employs one or more user devices 522, each of which may include a user interface 524. The user interface 524 can be programmed for accessing the system 502 and implementing the functions and methods shown and described herein. For example, in response to a user input provided via the user interface 524, the visualization engine 506 can employ the repository interface 508 to access data from an EHR system 526 in which EHR data 528 is stored. The visualization engine 506 thus can employ the repository interface 508 to retrieve health data objects and other information from the EHR system 526 as well as from one or more other data sources 530 for generating an interactive graphical map 510, such as shown and described herein.

There can be different groups of health data objects stored in the EHR 526 that can be utilized by the visualization engine. For instance, the health data objects can include problem data objects representing problems that form a problem list for each given patient. There can also be intervention data objects representing interventions initiated by a user for the given patient. As another example, the clinical data objects can be stored in the EHR system 526, representing clinical data acquired for the given patient.

For example the visualization engine 506 can receive one or more lab values, one or more orders, radiology information and risk factors as inputs for a given patient. Based upon corresponding rules (e.g., see FIG. 2), the visualization engine 506 can generate a suggested link and/or generate a suggested problem (e.g., a diagnosis) that can be presented graphically in the interactive map. The suggested links or problems then can be validated or invalidated by the user to create the corresponding link and problem. As shown and described herein, each action and operation by a user on the graphical elements results in corresponding data being generated as part of the encounter to track and log each step in the medical decision making process. For instance, each step thus can be stored as encounter data and corresponding data can be coded according to appropriate standards (e.g., ICD-9, ICD-10, procedure codes and the like) and provided back to the EHR system 526. The information that is provided to the EHR system 526 can be utilized for billing purposes for the care that was provided and documented via the system.

The system 502 can also employ one or more device interfaces 514 for monitoring one more monitoring devices 532. Monitoring devices 532 can monitor any health related condition in real time to provide real time patient data indicative of a biological parameter of a patient, such as disclosed herein. The parameter can correspond to supporting evidence that can be programmatically associated with one or more diagnoses.

The system 502 can also communicate (e.g., retrieve and send) information relative to one or more other services 533. Such other services, for example, can include billing systems, insurance systems (internal to the organization or third party insurers), Personal Health Records, scheduling systems, admission discharge transfer (ADT) systems, prediction services, patient health portals or the like. In this way, the system can leverage information from a variety or resources and present users with current information that can be relevant to each patient or to groups of patients. The current information (as well as historical data) can be utilized to populate the interactive map with supporting evidence for one or more diagnoses that can be computed by the visualization engine 506 or manually created in response to a user input, as disclosed herein.

The system 500 further may employ a messaging system 534 for sending messages and alerts to one or more predetermined individuals that can be programmed into the system 502. The type messaging may include for example, email, alphanumeric paging, telephone, PA announcement or any combination of these or other message types. For example, if an actual or predicted condition is outside of the an expected parameter, the system 502 can trigger an alert to instruct the messaging system 534 to issue one or more messages to appropriate personnel (e.g., caregivers) so that appropriate action can be taken.

In still other examples, the system 500 may operate in an investigational or study mode in which health objects may be retrieved from the EHR and utilized for purposes of study or evaluation. However, in such mode, data is not sent back to the EHR system 526 for a given patient. Instead, the user can manipulate data elements and connections, add new interventions, clinical data and problems and allow the system to graphical demonstrate how the health data objects are related and how changes or new data might affect diagnoses.

As will be appreciated by those skilled in the art, portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention are described herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

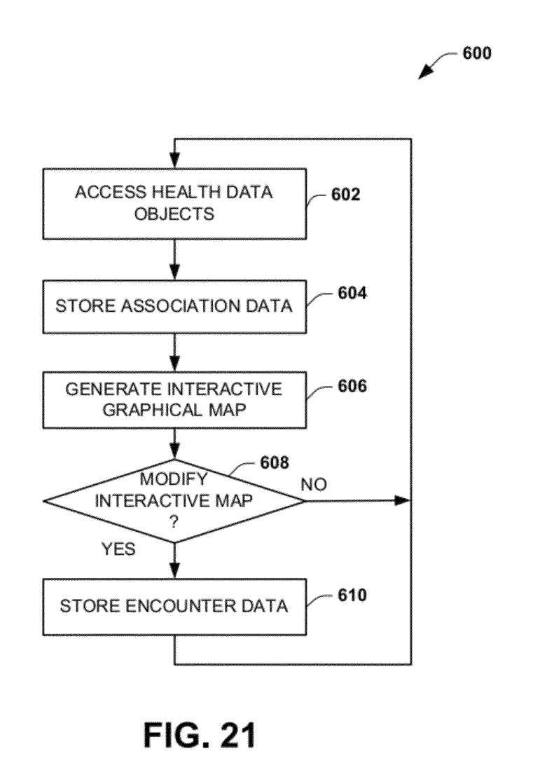

In this regard and in view of the foregoing structural and functional features described above, an example method will be better appreciated with reference to FIG. 21. While, for purposes of simplicity of explanation, the example method of FIG. 21 is shown and described as executing serially, the present examples are not limited by the illustrated order, as some actions could in other examples occur in different orders and/or concurrently from that shown and described herein. Moreover, it is not necessary that all described actions be performed to implement a method and other actions can be combined with those shown as disclosed herein. The example method of FIG. 21 can be implemented as computer-readable instructions that can be stored in a non-transitory computer readable medium such as can be computer program product. The computer readable instructions corresponding to the methods of FIG. 21 can also be executed by a processor (e.g., the processing unit 516 of FIG. 20).

FIG. 21 is a flow diagram depicting an example of a method 600 for providing interactive visualization of healthcare information for a given patient. At 602, the method includes accessing health data objects for a given patient from an EHR system (e.g., EHR system 526 of FIG. 20). At 604, association data can be stored to represent a link between health data objects for the given patient. As disclosed herein, the association data can be stored separately from the EHR system (e.g., stored in local storage 22 of FIG. 1). At 606, an interactive graphical map can be generated. The map can be dynamically generated to represent selected health data objects as graphical elements and to represent links between the selected health data objects as graphical connections between related graphical elements based on the association data.

At 608, a determination is made whether the interactive map is modified. The modifications to the map can be made automatically, in response to additional health data for the given patient, such as can be obtained from the EHR system, other services or devices. Additionally or alternatively, the modifications can be made in response to a user input. The modifications can correspond to changes in properties of currently displayed elements, validating or invalidating suggested links or elements as disclosed herein. If no changes are made, the method can return to 602. If changes are made, the method proceeds to 610 in which encounter data corresponding to such changes can be stored. The encounter data thus can provide a record of medical decision making, as disclosed herein. The encounter data can also be sent to the EHR system. From 610, the method can return to 602 and continue accordingly.

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system for visualizing health information, comprising:
a repository interface to access health data objects for a given patient from an electronic health record (EHR) repository;
association data stored in memory separate from the EHR repository, the association data representing a link between selected health data objects for the given patient; and
a visualization engine to dynamically generate an interactive graphical map representing selected health data objects as graphical elements and representing links between the selected health data objects as graphical connections between related graphical elements based on the association data.

2. The system of claim 1, wherein the association data further comprises relevance data corresponding to a relevance value representing a determined association between a pair of health data objects.

3. The system of claim 2, wherein the visualization engine is programmed to generate the interactive graphical map to graphically differentiate a relative importance of the selected health data objects and the links between the selected health data objects based on the relevance data.

4. The system of claim 2, wherein the graphical connections comprise at least one relative graphically-represented parameter that is set according the relevance data.

5. The system of claim 4, wherein the relative graphically-represented parameter of the graphical connections comprises at least one of a relative length parameter and a relative thickness parameter.

6. The system of claim 1, wherein the graphical elements in the interactive graphical map comprise iconic representations of patient health data.

7. The system of claim 1, further comprising user controls to graphically modify the interactive graphical map in response to user inputs.

8. The system of claim 7, further comprising a document generator programmed to generate encounter data by capturing a process of clinical decision-making in response to the graphical modifications to the interactive graphical map and based on graphical actions performed on unassociated graphical elements, the encounter data being provided to the EHR repository via the repository interface.

9. The system of claim 8, wherein the document generator is programmed to assemble into a user-perceptible document defined by the encounter data that includes at least one of (i) metadata for each link between the selected health data objects, represented by the graphical connections in the interactive graphical map, (ii) health data objects for diagnostic concepts, represented by the graphical elements in the interactive graphical map, (iii) health data objects for lab data, represented by the graphical elements in the interactive graphical map, and (iv) health data objects for interventions, represented by the graphical elements in the interactive graphical map.

10. The system of claim 9, wherein the user-perceptible document provides data supporting proof of at least one of patient management and review of patient medical data.

11. The system of claim 7, wherein the visualization engine is programmed to display new graphical elements, corresponding to new health data objects not linked to any of the selected health data objects and separate from the interactive graphical map, the user controls being programmed to modify the interactive graphical map by graphically linking a user-selected one of the new graphical elements with at least one of the selected graphical elements via a dynamically created graphical connection, metadata for the graphical link being stored in the memory as part of the association data for the given patient.

12. The system of claim 11, wherein the graphical link is created by graphically dragging a given graphical element into a superimposition relative to another graphical element in response to a user input, such that the association data for the graphical link is generated for the resulting graphical link.

13. The system of claim 11, further comprising a health element generator programmed to generate a new graphical element and a corresponding health data object for the given patient, the corresponding health data object being stored as encounter data and provided to the EHR repository via the repository interface.

14. The system of claim 13, wherein the health element generator is programmed to automatically generate the new graphical element automatically based on analysis of health data objects received from the EHR repository for the given patient.

15. The system of claim 13, wherein the health element generator is programmed to generate the new graphical element and the corresponding health data object for the given patient in response to a user input, the corresponding health data object being stored in the EHR repository.

16. The system of claim 1, further comprising user role data stored in the memory for each of a plurality of users, the interactive graphical map varying in content and organization depending on the user role data for a given user of the system.

17. The system of claim 16, wherein the user is logged into the system with a user role, which comprises one of a physician, nurse or patient.

18. The system of claim 16, wherein the user role data further comprises user preference data stored in the memory, the user preference data for a current usage by a respective user being set based on prior usage of the system by the respective user, the system further comprising a display control to select the selected health data objects for use in generating the interactive graphical map and to arrange the interactive graphical map for the current usage according to the user preference data.

19. The system of claim 1, further comprising a rules engine programmed to evaluate health data objects for the given patient, to determine a relevance between health data objects and to suggest a link between health data objects as a suggested graphical connection between corresponding graphical elements, the suggested graphical connection being graphically differentiated from the graphical connections in the interactive graphical map until validated or invalidated in response to a user input.

20. The system of claim 19, wherein the suggested graphical connection has a graphical characteristic that varies as a function of a computed confidence that the health data objects being linked are related.

21. The system of claim 19, wherein the rules engine is programmed to analyze the health data objects and links between health data objects in the interactive graphical map in response to user-manipulation or user-modification thereof, encounter data being stored to reflect each user-manipulation or user-modification.

22. The system of claim 1, wherein the visualization engine comprises a diagnosis engine, the diagnosis engine being programmed to generate the interactive graphical map such that the graphical connections between the selected graphical elements in the interactive graphical map represent the association data in relation to at least one diagnosis for the given patient relating to the selected health data objects.

23. The system of claim 22, further comprising a rules engine programmed to evaluate the health data objects for the given patient by application of a set of predetermined rules and to generate a suggested graphical link between graphical elements in the interactive graphical map, the suggested graphical link corresponding to a diagnostic relationship between a potentially-related set of health data objects.

24. The system of claim 23, wherein the potentially-related set of health data objects comprises at least two of (i) health data objects for diagnostic concepts, represented by the graphical elements in the interactive graphical map, (ii) health data objects for lab data, represented by the graphical elements in the interactive graphical map, and (iii) health data objects for interventions, represented by the graphical elements in the interactive graphical map, the relationship between the potentially-related set of health data objects being represented as a graphical connection between corresponding graphical elements in the interactive graphical map according to metadata stored in the memory as part of the association data.

25. The system of claim 23, wherein the suggested graphical link is graphically differentiated from the graphical connections in the interactive graphical map until validated or invalidated by a user.

26. The system of claim 23, the diagnosis engine is programmed to evaluate the health data objects and links between data objects based on the association data for the given patient and to graphically suggest a potential problem for the given patient as a new graphical element that is graphically differentiated from the graphical elements in the interactive graphical map until the new graphical element is validated or invalidated by a user.

27. The system of claim 26, wherein the validation or invalidation of the new graphical element by the user is recorded as medical-decision making data related to at least one of patient management and review of clinical data for the given patient, the medical-decision making data being provided for storage in the EHR repository via the repository interface.

28. The system of claim 1, wherein the visualization engine generates the interactive graphical map as a three-dimensional graphical representation in which the graphical elements and related links are arranged hierarchically in three-dimensions according to their relative importance in driving a diagnosis for the given patient.

29. The system of claim 1, wherein the health data objects comprise temporal data indicating a time associated with the underlying health information,
wherein the association data for each link comprises temporal data indicating a time when the link between associated health data objects was validated or invalidated, and
the visualization engine being programmed to vary the interactive graphical map as based on the temporal data.

30. The system of claim 29, further comprising controls programmed to animate the interactive graphical map for the given patient over a time period based on the health data objects and the association data as a function of the temporal data, temporal changes being presented in the interactive graphical map to graphically represent medical decision making over time for the given patient.

31. The system of claim 1, wherein the health data objects are selected as a group comprising at least one of:
problem data objects representing problems that form a problem list for the given patient;
intervention data objects representing interventions initiated by a user for the given patient; and
clinical data objects representing clinical data acquired for the given patient.

32. The system of claim 31, further comprising a documentation generator programmed to record, as medical decision-making data, user-manipulation of the graphical elements representing health data objects and user-manipulation of the graphical connections representing links between the selected health data objects to document at least one of patient management and review of clinical data for the given patient, the medical decision-making data being provided for storage in the EHR repository via the repository interface.

33. A non transitory computer readable medium that stores instructions for performing a method comprising:
accessing health data objects for a given patient from an electronic health record (EHR) system;
storing association data to represent a link between health data objects for the given patient, the association data being stored separately from the EHR system; and
dynamically generating an interactive graphical map representing selected health data objects as graphical elements and representing links between the selected health data objects as graphical connections between related graphical elements based on the association data.

34. The medium of claim 33, wherein the method further comprises graphically modifying the interactive graphical map.

35. The medium of claim 34, wherein the method further comprises generating encounter data by capturing a process of clinical decision-making of the user in response to the graphical modifications to the interactive graphical map.

36. The medium of claim 34, wherein the method further comprises:
generating new graphical elements, corresponding to new health data objects not yet linked to any of the selected health data objects;
modifying the interactive graphical map by graphically linking a user-selected one of the new graphical elements with at least one of the selected graphical elements via a dynamically created graphical connection; and
storing metadata corresponding to the graphical link in memory as part of the association data for the given patient.

37. The medium of claim 34, wherein the graphical link is created by graphically dragging a given graphical element into a superimposition relative to another graphical element in response to a user input, such that the association data for the graphical link is generated for the resulting graphical link.

38. The medium of claim 34, wherein the method further comprises:
generating a new graphical element and a corresponding health data object for the given patient;
storing the corresponding health data object as encounter data; and
providing the encounter data to the EHR system.

39. The medium of claim 38, wherein the new graphical element and the corresponding health data object are one of (i) automatically generated based on analysis of health data objects received from the EHR system for the given patient or (ii) generated for the given patient in response to a user input.

40. The medium of claim 33, wherein the method further comprises varying in content and organization depending on user role data that is stored for each respective user.

41. The medium of claim 33, wherein the method further comprises:
evaluating health data objects for the given patient to determine a relevance between health data objects
generating a suggested link between health data objects as a suggested graphical connection between corresponding graphical elements, the suggested graphical connection being graphically differentiated from other graphical connections in the interactive graphical map until validated or invalidated in response to a user input.

42. The medium of claim 41, wherein the suggested graphical connection has a graphical characteristic that varies as a function of a computed confidence that the health data objects being linked are related.

43. The medium of claim 33, wherein the method further comprises:
analyzing the health data objects and links between health data objects in the interactive graphical map in response to user-manipulation or user-modification thereof, and
storing encounter data in response to the user-manipulation or user-modification.

44. The medium of claim 33, wherein the graphical connections between the selected graphical elements in the interactive graphical map represent the association data in relation to at least one diagnosis for the given patient relating to a selected set of health data objects, the method further comprising:
applying a set of predetermined rules to evaluate the health data objects for the given patient; and
generating a suggested graphical link between graphical elements in the interactive graphical map, the suggested graphical link corresponding to a diagnostic relationship between a potentially-related set of health data objects.

45. The medium of claim 44, wherein the potentially-related set of health data objects comprises at least two health data objects comprising (i) health data objects for diagnostic concepts, represented by the graphical elements in the interactive graphical map, (ii) health data objects for lab data, represented by the graphical elements in the interactive graphical map, and (iii) health data objects for interventions, represented by the graphical elements in the interactive graphical map,
wherein the relationship between the at least two health data objects is represented as a graphical connection between corresponding graphical elements in the interactive graphical map according to metadata stored as part of the association data.

46. The medium of claim 45, wherein the suggested graphical link is graphically differentiated from the graphical connections in the interactive graphical map until validated or invalidated in response to a validation user input.

47. The medium of claim 44, wherein the method further comprises recording the validation or invalidation of the suggested graphical link as medical-decision making data related to at least one of patient management and review of clinical data for the given patient, the medical-decision making data being provided for storage in the EHR system.

48. The medium of claim 33, wherein the association data further comprise temporal data indicating a time associated with the underlying health information,
wherein the association data for each link comprises temporal data indicating a time when the link between associated health data objects was validated, and
the method further comprising varying the interactive graphical map as based on the temporal data.

49. The medium of claim 48, wherein the method further comprises animating the interactive graphical map for the given patient over a time period based on the health data objects and the association data that vary as a function of the temporal data, temporal changes being presented in the interactive graphical map to graphically represent medical decision making for the given patient over the time period.
